(19) United States
(12) Patent Application Publication
(10) Pub. No.: US 2026/0169668 A1
(43) Pub. Date: Jun. 18, 2026

(54) SYSTEMS AND METHODS FOR PRESENTING MULTI-DISPLAY CONTENT BASED ON DEVICE SPATIAL ARRANGEMENT

(71) Applicant: Adeia Guides Inc., San Jose, CA (US)

(72) Inventors: Aldis Sipolins, Somerville, MA (US); Dhananjay Lal, Englewood, CO (US); Jean-Yves Couleaud, Mission Viejo, CA (US); Tao Chen, Palo Alto, CA (US)

(21) Appl. No.: 18/978,788

(22) Filed: Dec. 12, 2024

(51) Int. Cl. G06F 3/14; H04N 21/43

(52) U.S. Cl. CPC G06F 3/1423; H04N 21/43076

(57) ABSTRACT

Methods and systems, e.g., implemented by a server and/or user device, are disclosed herein for enabling the improved and coordinated output of multiple content on multiple devices. This may allow for increasing simultaneous user engagement with each content and saving network bandwidth resources when a plurality of devices are simultaneously streaming each a content. A multi-display media content is selected for display at a first device and at a second device. A spatial map comprising positions and orientations of the first and second devices is accessed. The positions and orientations of the first and second devices in the spatial map are tracked and a dynamic synchronization parameter is determined based on the tracked positions and orientations of the first and second devices. Additionally, the multi-display media content is generated for display at the first and second devices based on the dynamic synchronization parameter.

### BACKGROUND

The present disclosure relates to methods and systems presenting content (e.g., at least two different audio and/or visual content items) on multiple devices. In particular, but not exclusively, the systems and methods use spatial mapping of multiple devices, enabling the improved and coordinated presentation of a multi-component media content across the multiple devices.

### SUMMARY

Modern consumers experience media across a range of devices and displays (e.g., smartphones, TVs, home assistant devices), but media is typically limited to a single display. For example, if you are watching TV while looking at your smartphone, a user may see separate content on both devices, as if viewed in isolation. In order to improve user interaction, content on a device may be modified at least based on, for instance, a position and an orientation of the device presenting the content item. In some approaches such as in Pokémon Go® game, a virtual creature from the Pokémon® universe is assigned, in a 3D map, a location characterized by a set of 3D coordinates (e.g., GPS coordinates). A user is to access the location of the virtual creature by moving such that the difference between the GPS coordinates of a user device (e.g., tablet, mobile phone and the likes) they use and the GPS coordinates associated with the virtual creature are small enough for the mobile phone to generate a depiction of the virtual creature superimposed on an image associated with the field of view (FOV) of a camera of the user device. However, the content item presented on the user device is modified based on the position of the user device in the 3D map that determines the presentation or non-presentation of the virtual creature, and on the FOV captured by the user device camera which depends upon the position and orientation of the user device camera in the real world scene.

In some approaches, the content of a content item may be modified at least based on, for instance, relative positions and orientations of the device presenting the content item and another device presenting another content item. For example, such as disclosed in U.S. patent application Ser. No. 18/505,937, a display of a user device (e.g., a TV, a computer, a laptop, a tablet, a mobile phone and the likes) may sequentially present, to a user, cropped frames of a content item. Concomitantly, an augmented reality (AR) display worn by the user may sequentially present content associated with the cropped frames of the content item. Such approaches may thus allow for extending the display of a user device using an AR display, so as to present an extended version of each frame of the content item. However, the coherent arrangement of each cropped frame/content associated with the cropped frame pair may require having the user device display within a FOV of the AR display to properly position and orient the content presented by the AR display, relative to the user device.

In some approaches, multiple devices controlled by a single user may each present simultaneously a content item. For example, a smartphone and a smart TV controlled by a same user may simultaneously present a YouTube video disclosing how to complete a level in a platform video game (such as ‘Prince of Persia, the Two Thrones’) and a movie (such as ‘The Equalizer 2’), respectively. A user is to devote their attention to a single content item at a time, and there is no need to coordinate the display of the separate content items. However, in a scenario where the content items are related or made related (e.g., by having an element going from one content item to the other one), it is desirable to deliver such related content items to respective devices in an efficient and coherent manner. This may promote simultaneous user engagement with both related content items. As such, there is a need to develop a strategy for optimizing or enhancing network bandwidth resources when one or more devices are simultaneously presenting associated content items.

Methods and systems, e.g., implemented by a server and/or user device, are disclosed herein for enabling the improved and coordinated output of multiple content on multiple devices. Such methods and systems may detect the capabilities and relative spatial arrangement of available display devices, identify a piece of multi-display media (e.g., sports event, advertisement, video, game level, etc.) that is compatible with the detected arrangement and capabilities, and initiate and synchronize playback of multi-display media content across available devices. During media playback, the positions/orientations of the devices may be tracked in real time, and the displayed media content may be updated in response. For example, the content displayed on first and second devices may be affected by the relative positions and orientations of the first and second devices. In some example, the content displayed at each device may be selected and/or modified based on the relative positions and orientations of the devices, e.g., to account for viewing the multi-display media content from different positions/orientations represented by the positions and orientations of the devices. Because a user may control the position and orientation of at least one of the devices and thus may determine in part the content displayed at each device, the disclosed methods and systems may reinforce user engagement with the content displayed at each device. This increased user engagement may be leveraged, for example, to provide supplemental content different from the multi-component media content.

In some examples, a multi-component media content is selected for presentation at a first device and a second device. A spatial map comprising positions and orientations of the first and second devices is accessed. The positions and orientations of the first and second devices in the spatial map are tracked. A dynamic synchronization parameter based on the tracked positions and orientations of the first and second devices is determined. And the multi-component media content is generated, for presentation at the first and second devices, based on the dynamic synchronization parameter.

In some instances, the multi-component media content may be presented on multiple devices, each configured to present a respective audio and/or visual content item of the multi-component media content. The multi-component media content may comprise, e.g., multi-display media content, multi-speaker media content, speaker and display media content.

In some instances, the multi-component media content may be generated (e.g., designed) specifically for a use case involving multiple audio and/or visual devices. For example, each component of the multi-component media content may be generated as a part of an overall delivery of the multi-component media content. For example, the generation or presentation of a first component of the multi-component media content may be based on the generation or presentation of a second component of the multi-component media content, e.g., where there exists an interoperability or interactivity between the first and second components.

In some instances, the multi-component media content may comprise a component configured to be presented, e.g., initially, as standalone content. For example, first media content may be a transmission of a sport event, configured for presentation on a display device. The first media content may be supplemented by a second media content, e.g., transmission of an alternative part of the sports event. The first media content may be combined, e.g., selectively, with the second media content to generate multi-component media content.

In some instances, the multi-component media content may result from association of a first media content (e.g., content for general transmission) and a second media content (e.g., which supplements, on demand, the first media content). In some instances, the first media content and second media content may be associated with a target (e.g., a location where an event occurs, that may involve, for example, a character or an object performing an action). In some instances, the first media content and second media content may relate to different content and may be able to share a cause/consequence relationship. In some instances, each of the first media content and second media content may be, for example, a visual and/or audio program. In some instances, each of the first media content and second media content may be a transmission content (e.g., a stream depicting an event that may be live or not) or user-requested content. In some instances, each of the transmission content and the user-requested content may be associated with a sport event, a movie, a news coverage, a political debate, a show, a reality show, a concert, etc.

In some instances, all the aforementioned steps are performed by a server in communication with the first and second devices via a communication network (e.g., LAN or WAN). Alternatively, all the aforementioned steps are performed by at least one of the first and second devices, both in communication with a server via a communication network.

The aforementioned steps may increase user engagement towards the multi-component media content presented on the first and second devices by having the user position and orient at least one of the first and second devices so as to possibly cause a change in the multi-component media content presented on first and second devices. In some instances, the multi-component media content may comprise a game presented on the first and second devices. Additionally or alternatively, the multi-component media content may comprise an advertisement.

In some instances, the multi-component media content may comprise at least one of live content, prerecorded content, and interactive content. In some instances, the multi-component media content may be a multi-display media content and/or multi-speaker media content. In some instances, the multi-component media content may comprise a first content to be presented on the first device and a second content to be presented on the second device. Each of the first content and second content may comprise at least one audio and/or visual content item. Each of the first content and second content may comprise at least one of live content, prerecorded content, and interactive content. In some instances, the first content and second content may depict a first perspective and a second perspective of a same target (e.g., a location where an event occurs, that may involve, for example, a character or an object performing an action), which may be different from, similar to or identical to each other, depending on the relative positions and orientations of the first and second devices. A perspective corresponds to a FOV of an imaging device of a plurality of imaging devices (e.g., cameras), wherein the plurality of imaging devices is arranged around the same target.

In some instances, the first content and second content are compatible such that the first content presented on the first device may impact the second content presented on the second device, depending on the relative positions and orientations of the first and second devices, wherein the first content and second content may be or not portions of a same content. In some instances, the first content and second content may be portions of a content associated with a feed of a same imaging device. In some instances, the first content and second content were simultaneously captured by the same imaging such that the first content and second content may be comprised into a same sequence of consecutive frames. The first content and second content may thus be comprised into a same perspective generated by the same imaging device. In some instances, the first content and second content were captured at different periods of time by the same imaging device such that the first content and second content are comprised into different sequences of consecutive frames. In some instances, each of the first content and second content may be a portion of a content associated with a feed of a respective imaging device, wherein each of the respective imaging devices may simultaneously capture a same target (e.g., a location where an event occurs, that may involve, for example, a character or an object performing an action) such that the first content and second content are comprised into different sequences of consecutive frames. The same target may be thus imaged from respective viewpoints to generate respective perspectives of the same target. In some instances, each of the first content and second content may be a portion of a content associated with a feed of a respective imaging device, wherein each of the respective imaging devices may simultaneously capture a respective target (e.g., a location where an event occurs, that may involve, for example, a character or an object performing an action) such that the first content and second content are comprised into different sequences of consecutive frames.

For example, when the first content and second content are portions of different content, the first device and second device may present the first content and second content as if the first content and second content were at least a portion of a first perspective of a target (e.g., a location where an event occurs, that may involve, for example, a character or an object performing an action) generated by a first imaging device, and at least a portion of a second perspective of the target generated by a second imaging device, respectively. In some instances, the first perspective may be same as the second perspective, which implies that the first imaging device is same as the second imaging device. In some instances, the first perspective may be different from the second perspective, which implies that the first imaging device is different from the second imaging device. In some examples, the first content and second content may appear to be captured from a FOV of a notional single imaging device. In some examples, the first content and second content may appear to be captured from a respective FOVs of notional first and second imaging devices. In some examples, the FOV of a notional imaging device may appear to change based on the movement of one of the first and second devices relative to the other, e.g., around the same target and to capture a respective perspective of the same target.

For example, when one of the first and second devices changes from a first position to a second position, the first content and second content presented on the first and second devices, respectively may be modified. The first device presents, as the first content, at least a portion of a perspective of a target (e.g., a location where an event occurs, that may involve, for example, a character or an object performing an action) associated with the second position, that may be different from at least a portion of a perspective of the target associated with the first position, if the second position is sufficiently different from the first position, e.g., above a threshold difference. The second device presents, as the second content, at least a portion of a perspective of the target associated with the second position, which may be different from a perspective associated with the first position, if the second position is sufficiently different from the first position, e.g., above a threshold difference.

In some instances, the first content may comprise a plurality of first versions, each first version being associated with at least a portion of a respective perspective of a target (e.g., a location where an event occurs, that may involve, for example, a character or an object performing an action), as if each respective perspective of the target were to correspond to an image captured, by a camera rotating around the target and stopping at a respective angle (e.g., between 0 and 360°). Similarly, the second content may comprise a plurality of second versions, each second version being associated with at least a portion of a respective perspective of the target, as if each respective perspective of the target were to correspond to an image captured, by a camera rotating around the target and stopping at a respective angle (e.g., between 0 and 360°).

In some instances, the first content may comprise a plurality of first versions, each first version being associated with a respective outcome in the first content. Similarly, the second content may comprise a plurality of second versions, each second version being associated with a respective outcome in the second content. The first and second devices may present a first outcome in the first content and a second outcome in the second content, respectively, such that the first and second outcomes are coherent with each other and obey, more or less rigorously, e.g., the laws of physics governing the real world, or artificial laws governing an imaginary world. Accordingly, a version of the first content presented on the first device may restrict a number of selectable versions of the second content to be presented on the second device.

Furthermore, the real world may comprise, e.g., the Earth, the moon or any other element of our Universe, and the laws of physics governing the real world are location-dependent. For instance, the gravity on Earth is different from the gravity on the moon. In an imaginary world, gravity may, for example, be set to zero.

In some instances, a presentation of the first content may pause or stop during a presentation of the second content on the second device. This may save network bandwidth resources. Alternatively, the first content may continue being presented on the first device during the presentation of the second content on the second device.

In some instances, the first content and second content may be temporally coherent (e.g., time-synchronized) such that a portion of the first content presented on the first device may cause, with a time delay (e.g., from zero to several seconds), a presentation of the second content on the second device. Alternatively or additionally, the first content and second content may comprise a similar element (such as a character, or an object, e.g., a ball, a water drop, etc.), wherein the similar element presented in the first content (presented on the first device) for a first period of time is presented in the second content presented on the second device for a second period of time. The first content and second content are made temporally coherent by setting the second period of time to be subsequent to the first period of time. A time delay between the first and second periods of time may be equal from zero to several seconds. The time delay between the first and second periods of time may be based on (e.g., equal or proportional to) a ratio of a distance between the first and second devices to a velocity of the similar element as if the similar element were to travel from the first device to the second device.

In some instances, the first content and second content may be spatially coherent such that the first content presented on the first device may present at least a portion of a first perspective of a target (e.g., a location where an event occurs, that may involve, for example, a character or an object performing an action) and the second content presented on the second device may present at least a portion of a second perspective of the target. The at least a portion of the first perspective (presented on the first device) and the at least portion of the second perspective (presented on the second device) depend upon a spatial relationship between the first and second devices, the spatial relationship being based on the real-time positions and orientations of the first and second devices. For example, the first device may be located in a background (relative to a user facing the first device) and affixed to a wall so as to have a center of the first device superimposed upon a center of the wall, while the second device may be initially located in a foreground (relative to the user), parallel to the wall, such that a center of the second device faces and aligns with the center of the first device. The second device (e.g., being portable) may be moved (by the user), according to a circular motion (whose axis passes through the wall center and the point resulting from a projection of the wall center on a floor), from the initial location to a current location located right of the initial location (using the user's right hand as a reference for right). The initial at least a portion of the second perspective of the target may represent a zoomed-out front view of the at least a portion of the first perspective of the target. The current at least a portion of the second perspective of the target represents a zoomed-out right view of the at least a portion of the first perspective of the target. If the second device from the current location is brought closer to or more distant from the first device, the at least a portion of the second perspective of the target depicts a more zoomed-in right view of the at least a portion of the first perspective of the target or a more zoomed-out right view of the at least a portion of the first perspective of the target.

In some instances, the first content and second content may be spatially coherent such that the first content presented on the first device may present the similar element leaving the first content at a respective velocity and following a respective trajectory, and the second content presented on the second device may present the similar element when parameters (e.g., respective trajectory and respective velocity of the similar element, relative positions/orientations of the first and second devices associated with relative positions/orientations of the first content and second content, respectively) are adequate according to Newton's laws of motion to have the similar element reach the second device in order to be presented in the second content after a time delay based on the ratio of a distance between the first and second devices to a velocity of the similar element. When the aforementioned parameters are not adequate according to Newton's laws of motion, the second content may not present the similar element. In some instances, the parameters may need to be within a respective range of values to be considered adequate according to Newton's laws of motion. In some instances, the parameters may need to be adequate according to artificial laws governing an imaginary world. In some instances, the parameters may need to be within a respective range of values to be considered adequate according to artificial laws governing an imaginary world.

In some instances, each of the first and second devices may be configured to present an audio and/or visual content and may thus comprise a display and/or a speaker. In some instances, the first and second devices may be selected from a list of eligible nearby devices that may participate in the presentation of the multi-component media content, the list being established by a device manager. In some instances, the list of eligible nearby devices may be retrieved from a smart home service (e.g., Google Home®, Apple Home®) or dynamically populated based on devices accessing a same communication network (e.g., a LAN or WAN). In some instances, the device manager may refine the list of eligible nearby devices by setting up a threshold maximum distance between the first and second devices, e.g., based on a peer-to-peer communication protocol, e.g., Bluetooth Low Energy, or Wi-Fi Direct.

In some instances, the positions and orientation of the first device, may be determined, in real time, using one or more internal sensors (e.g., an accelerometer, a geomagnetic field sensor, a gyroscopic sensor) within the first device. Similarly, the positions and orientation of the second device, may be determined, in real time, using one or more internal sensors (e.g., an accelerometer, a geomagnetic field sensor, a gyroscopic sensor) within the second device. Additionally or alternatively, the positions and orientations of the first and second devices, may be determined, in real time, using one or more external sensors (such as cameras) placed in a same location as a location where the first and second devices are located. In some instances, the spatial map may be generated at least in part based on the positions and orientations, of the first and second devices, determined in real time by internal sensors and/or external sensors, so as to locate the first and second devices within a geographical zone (e.g., a room, a plurality of rooms, a house and the likes) and indicate the respective orientations of the first and second devices in the spatial map. In some instances, tracked first and second devices may use existing techniques such as shared cloud anchors to detect a known spatial map by identifying a combination of tracked environmental feature points.

In some instances, a device, e.g., stationary or mobile, may appear on the spatial map as an icon. In some instances, a device (e.g., the first device, the second device, a device other than the first and second devices, etc.) may be assigned a respective icon comprising information related to the device. In some instances, the related information may comprise features of the device (e.g., device type, display size, resolution, presentable sound frequency range, presentable sound intensity range, etc.), a real-time position of the device (e.g., real-time coordinates in a referential based on the x-axis, y-axis and z-axis), a real-time orientation of the device (e.g., real-time vector normal to a plane considered to represent a device whose components on each of the x-axis, y-axis and z-axis indicate the real-time device orientation, etc.), one or more hyperlinks pertinent to the device (e.g., to access a webpage of a distributor or manufacturer of the device, a user manual of the device, a forum related to the device, etc.). In some instances, the related information may be accessible upon user interface input.

The device comprising a display is considered to be a plane whose orientation in a referential based on the x-axis, y-axis and z-axis is indicated by a vector normal to the plane, having components on each of the x-axis, y-axis and z-axis.

In some instances, the dynamic synchronization parameter defining a coherence between the first content and second content may comprise a spatial component, a temporal component, and/or a content-oriented component. The dynamic synchronization parameter may evolve based on relative positions and orientations of the first device and second device. The spatial component may determine whether the first content and second content are comprised in a same perspective following the relative positions and orientations of the first device and second device, or each within a respective perspective following the relative positions and orientations of the first device and second device. The temporal component may determine whether there is a time relationship (e.g., time delay from zero to several seconds) between a presentation of a portion of the first content and a presentation of a portion of the second content. For instance, a portion of the second content may present a second outcome induced by a first outcome presented earlier in a portion of the first content. When the time delay equals to zero seconds, the portion of the first content and the portion of the second content may be presented concomitantly. The content-oriented component may determine whether there is or not a cause/consequence relationship between the first content and second content. For instance, a first version, corresponding to a first outcome of the first content (e.g., blower configured to displace air) may restrict the amount of selectable second versions, each corresponding to a respective second outcome, of the second content (e.g., a pile of tree leaves), that, for example, may comply more or less rigorously with the laws of physics governing the real world or may obey artificial laws governing an imaginary world. When the blower displaces air and is brought closer to the pile of tree leaves (a first outcome), tree leaves are inevitably dispersed away from the pile (a second outcome) and cannot remain in the pile, e.g., as the blower is moved away from the pile of leaves. Additionally, the displacing of air allows for dispersing the tree leaves away from the pile: the first outcome should occur before the second outcome. Furthermore, this example depicts a one-way interaction from the first content to the second content. Saving a history of the presented first content and second content is necessary to avoid presenting a second version of the second content that would not comply with the laws of physics governing the real world. In some instances, there may be a two-way interaction between the first content and second content, which may require, for example, the occlusion of the first device presenting the first content by the second device presenting the second content besides a coherence between the first content and second content.

In some instances, a third device located in between the first and second devices may visually and/or auditory materialize a movement of the aforementioned similar element from the first device to the second device. The third device may be configured to present a third audio and/or visual content. In some instances, the third device may modulate an intensity of an acoustic signal associated with the aforementioned similar element and control a position of a source of the acoustic signal so as to mimic a motion of the aforementioned similar element.

In some examples, the multi-component media content may be a multi-display media content comprising a first content for display at the first device and a second content for display at the second device. At least one of the first content and the second content is selected, for display, based on the dynamic synchronization parameter. A change in the dynamic synchronization parameter that is greater than a threshold value is determined. Additionally or alternatively, it is determined that, e.g., whether, the dynamic synchronization parameter, e.g., an absolute or approximate value of the dynamic synchronization parameter, is greater than a threshold value. The selected at least one of the first content and the second content is updated when the dynamic synchronization parameter and/or the change in the dynamic synchronization parameter is greater than the respective threshold values.

The dynamic synchronization parameter may describe a relationship (e.g., coherence) between the first content and second content. In some instances, a threshold value may correspond to an edge of a FOV of an imaging device (or an edge of a perspective generated by an imaging device), above which another FOV of another imaging device lies (or another perspective generated by another imaging device). A change in the relative positions/orientations of the first and second devices may induce a change in the dynamic synchronization parameter such that a new dynamic synchronization parameter may be greater than the threshold value, resulting in a change of perspective (of a target, e.g., a location where an event occurs, that may involve, for example, a character or an object performing an action) in at least one of the first content and second content. During a streaming of the first content and second content, this may cause, for example, a request for a first bitstream (or first tile), associated with a new perspective of the target, to be presented as the first content and/or a second bitstream (or second tile), associated with a new perspective of the target, to be presented as the second content. In some instances, a threshold value may correspond to an edge between a first area and a second area adjacent to the first area by the edge.

In some instances, each of the first area and second area are assigned a respective time delay between a presentation of a portion of the first content and a presentation of a portion of the second content. A change in the relative positions/orientations of the first and second devices may induce a change in the dynamic synchronization parameter such that a new dynamic synchronization may be greater than the threshold value, resulting in a change, e.g., an increase or decrease, in the time delay between the presentation of the portion of the first content and the presentation of the portion of the second content.

In some instances, the dynamic synchronization parameter may describe a spatial relationship between the first content and second content when the first content and second content are temporally coherent. For example, the spatial relationship between the first content and second content may be an angle between the first content and second content. The spatial relationship between the first content and second content may be a logical relationship, such as numbering of tiles in a tiled video representation. Or the logical relationship may be custom-defined for the content, for example, “top-left”, “top-right”, “bottom-left”, “bottom-right”, “stadium”, “stand” etc. The logical relationship may be either known inherently, or exchanged prior to a beginning of the multi-display media content presentation, such as the logical relationship derived from a manifest (e.g., Media Presentation Description file).

In some examples, a manifest having information relating to multiple bitstreams, each bitstream of the multiple bitstreams being associated with a respective imaging device. Additionally, a first bitstream for displaying the first content at the first device and a second bitstream for displaying the second content at the second device are selected, based on the dynamic synchronization parameter.

In some instances, an imaging device has a respective FOV that is captured at an incremental time unit and turned into a frame (corresponding to a respective perspective) so as to provide a set number of frames per second. The sequence of consecutive frames forms a stream that is forwarded as stream portions from the imaging device through a server to a user device (e.g., first device or second device). In some instances, the imaging device may be stationary over time such that the respective FOV of the imaging device remains the same over time. In some instances, the imaging device may be moving so as to change a position and/or an orientation of the imaging device such that the respective FOV captured may evolve with the movement of the imaging device.

In some instances, the manifest may comprise information relating to time-dependent positions and orientations of imaging devices capturing a target (e.g., a location where an event occurs, that may involve, for example, a character or an object performing an action). Additionally or alternatively, the manifest may comprise information (e.g., time-dependent outlines of FOVs, and positions thereof relative to the target) relating to FOVs captured by the imaging devices.

In some instances, the manifest may comprise information relating to a plurality of first versions of the first content, each first version being associated with a respective first outcome and/or at least a portion of a respective first perspective. Similarly, the manifest may comprise information relating to a plurality of second versions of the second content, each second version being associated with a respective second outcome and/or at least a portion of a respective second perspective.

In some instances, the manifest may comprise information relating to a dynamic synchronization parameter. The dynamic synchronization parameter may, for example, describe a first spatial relationship between the first device (presenting the first content) and the second device (presenting the second content), and may assist in a provision of a first imaging device feed to one of the first and second devices, and a second imaging device feed to the other one. The first and second imaging devices may be selected based on a second spatial relationship between the first and second imaging devices, such that the second relationship is the most similar (or most identical) to the first spatial relationship.

In some examples, the manifest may comprise information relating to a spatial relationship between the first imaging device and the second imaging device. Additionally, the spatial relationship between the first imaging device and the second imaging device may be mapped to tracked positions and orientations of the first and second devices. In some instances, the manifest may comprise information relating to spatial relationships (that may be, e.g., time-dependent or not) between imaging devices based on the positions and orientations of the imaging devices (that both may be, e.g., time-dependent or not).

In some instances, the first and second devices may present at least a portion of a first perspective of a target (e.g., a location where an event occurs, that may involve, for example, a character or an object performing an action) and at least a portion of a second perspective of the target, respectively. The at least a portion of a first perspective may be provided by a feed of one of the first and second imaging devices and the at least a portion of a second perspective by a feed of the other one such that a second spatial relationship between the first and second imaging devices is the most similar (or most identical) to a first spatial relationship between the first and second devices. This may allow a user to simultaneously watch the first and second perspectives of the target (so as to access more details of the target. The target in question may be a venue to accommodate a concert, a show, a sport event, etc. Moreover, by selectively moving at least one of the first and second devices, the at least one of the first and second devices may present, to the user, at least a portion of a perspective different from the at least a portion of the first perspective and the at least a portion of the second perspective, e.g., when there is one or more additional imaging devices arranged around the same target. If the imaging devices were to move, the at least a portion of the first perspective presented on one of the first and second devices and the at least a portion of the second perspective presented on the other one may change without the need for the first and second devices to move.

In some examples, a first stream for displaying the multi-display media content is received at the first device, the first stream comprising a manifest having information relating to multiple bitstreams in the first stream, and the multi-display media content comprising a first content and a second content. A first bitstream for displaying the first content at the first device, and a second bitstream for displaying the second content at the second device are selected, based on the dynamic synchronization parameter. The second bitstream may be caused, by the first device, to be transmitted to the second device.

In some instances, the first device may act as a proxy server for the first and second devices presenting the first content and second content. During adaptive bitrate (ABR) streaming, the first device may request, from a server, a first stream comprising a manifest, the first content and second content, over a first communication network (e.g., WAN). The first device may subsequently distribute the second content to a device (e.g., the second device or a device other than the first and second devices). In some instances, the first content and second content may comprise frames associated with FOVs of respective imaging devices (e.g., cameras). While presenting the first content, the first device, acting as proxy server, may use a push protocol (e.g., real-time messaging protocol—RTMP) for streaming live, over a second communication network (e.g., LAN), the second content on the second device.

In some instances, in accordance with MPEG-DASH streaming, each of first and second streams (wherein the first and second streams are associated with the first content and second content, respectively) may be tile-based encoded prior to being forwarded, from a server to a user device, as segments over the first communication network so as to enable, for example, a one-way or two-way interactions between the first content and the second content, and an augmentation of at least one of the first content and second content, via the addition of a virtual content using computer-generated imagery software. The use of tile based encoding and streaming may be intended for both the first content and second content so as to facilitate an establishment of a coherence between the first content and second content (that may be, e.g., temporal, spatial and/or based on a cause/consequence relationship), the coherence being defined by a dynamic synchronization parameter. For instance, a first tile in the first content may be associated with a second tile in the second content by determining a presentation time of the second tile based on a presentation time of the first tile. For instance, a first tile in the first content may be associated with a second tile in the second content by determining a viewpoint of a user encompassing the first tile and the second tile. For instance, a first tile in the first content may be associated with a second tile in the second content by determining that an element (e.g., a ball as shown in FIG. 2A-2E, water droplets as shown in FIG. 9A-9C, dirt particles as shown in FIG. 10A-10B) of the first tile is to move to the second tile. Therefore, decoding and presenting part of an assembly of bitstreams of multiple tiles is very useful in enabling the improved and coordinated output of multiple content on multiple devices.

In some examples, the second bitstream may be decoded into frames. An adjustment parameter for modifying a display of the frames may be determined based on the dynamic synchronization parameter. In some examples, the modified frames may be displayed, at the second device.

In some instances, the dynamic synchronization parameter may take into account a change of position and orientation of each of the first and second devices, and a consequence induced by said change on at least one of the first content (e.g., presented on the first device) and the second content (e.g., presented on the second device). For instance, if the first device presents at least a portion of a first perspective of a target (e.g., a location where an event occurs, that may involve, for example, a character or an object performing an action) and the second device presents at least a portion of a second perspective of the target, and the first device is brought from a first position to a second position so as to be closer to the second device, both the first content and second content may be presented as if the frames of the first content and second content were zoomed-in. This may require scaling up the frames of first content and second content, using an adequate enlargement factor, and cropping the enlarged frames so as to fit in a display of the first device and a display of the second device. In some instances, the adjustment parameter may comprise an enlargement factor and a cropping parameter. Similarly, if the first device is brought from a first position to a second position so as to be further from the second device, the first content and second content may be presented as if the frames of the first content and second content were zoomed-out. This may require scaling down the frames of the first content and second content using an adequate reduction factor and adding pixels (e.g., around the frames of the first content and second content) blending with the background of the frames of the first content and second content so as to fit in a display of the first device and a display of the second device. In some instances, the adjustment parameter may comprise a reduction factor and a pixel addition parameter.

For instance, if the first content (presented on the first device) and the second content (presented on the second device) were from a same FOV captured by a notional imaging device, and the first device were brought from a first position to a second position so as to be closer to the second device, the second content may be presented as if the frames of the second content were zoomed-in. Additionally or alternatively, the first content may be presented as if the frames of the first content were zoomed-in. Similarly, if the first device were brought from a first position to a second position so as to be further from the second device, the second content may be presented as if the frames of the second content were zoomed-out. Additionally or alternatively, the first content may be presented as if the frames of the first content were zoomed-out.

In some examples, the multi-display media content comprises a first content for display at the first device and a second content for display at the second device. A playing of the first content may be initiated at the first device. A timing component of the dynamic synchronization parameter based on the spatial map (e.g., indicating a spatial relationship between the first and second devices) may be determined. An indication of playing of the first content at the first device may be received at the second device. The timing component may be exchanged between the first and second devices. A playing of the second content may be initiated based on the receiving the indication and the timing component. This may allow for enabling a one-way interaction from the first content to the second content or a two-way interaction between the first content and the second content.

In some examples, one or more capabilities of at least one of the first and second devices are determined. The multi-display media content may be selected based on the determined one or more capabilities. This may allow for optimizing a rendering of the first content on the first device and second content one the second device. In some instances, an icon associated with a device (e.g., the first device, second device or third device) and placed on the spatial map lists (e.g., automatically or upon a user input) technical features, of the device, related to content rendering. In some instances, an application may control, via a user profile, a presentation of the first content on the first device and a presentation of the second content on the second device, the user profile being associated with both the first and second devices (and possibly the third device mentioned earlier). The user profile may comprise information about technical features of each device associated with the user profile. Some of the technical features may relate to content rendering.

In some examples, content for display at the first and second devices is rendered based on the dynamic synchronization parameter. For example, the content may be for displaying at least a portion of an extended reality environment, such as an avatar in a virtual reality arena, or a menu screen in an augmented/mixed reality environment.

In some instances, the dynamic synchronization parameter may comprise instructions of a non-transitory computer-readable medium to superimpose graphic information (e.g., writing and/or drawing) upon at least one of the first content and second content. In some instances, an element of the first content may be copied and superimposed upon the second content, for example, to enable a first-way interaction from the first content to the second content. In some instances, the superimposed element (e.g., a water droplet from a leaking gutter presented in the first content) may be moving within the second content following the laws of physics governing the real world (e.g., to land in a bucket) or artificial laws governing an imaginary world.

This may differ from pre-recording virtual information, superimposing it as an overlay upon an image captured by a device sensor (e.g., a camera of a mobile phone) and presenting the augmented image on a device display (e.g., mobile phone display) as illustrated in the Pokémon Go® game example. The pre-recorded virtual information may be selected independently of the image captured by the device sensor, whereas, in the present disclosure, the virtual information to be superimposed upon at least one of the first content and second content may be dependent upon at least one of the first content and second content.

In some examples, the multi-display media content comprises a first content for display at the first device and a second content for display at the second device. A first occlusion state based on the spatial map may be determined, the first occlusion state being defined by at least a portion of one of the first and second devices occluding from view at least a portion of the other of the first and second devices. The first content for display at the first device and second content for display at the second device may be selected, based on the first occlusion state. A change from the first occlusion state to a second occlusion state may be determined, the second occlusion state being defined by at least a portion of one of the first and second devices occluding from view at least a portion of the other of the first and second devices. The first content for display at the first device and second content for display at the second device may be updated based on the change from the first occlusion state to the second occlusion state. This may require determining in real time which pixels of a display of the first device are occluded by the second device based on determined positions, orientations and sizes of first and second devices, and maintaining a state history of each pixel of each of the first and second devices. After having updated the spatial map, determined pixels may be input as an additional parameter, alongside updated positions and orientations of the first and second devices, to generate the next frame for the first and second devices. These steps may occur immediately after the spatial map is updated with the latest device positions.

In some examples, the disclosed systems and methods may have applications in the entertainment industry (e.g., video games), education sector (e.g., learning simulations) and industrial sector (e.g., controlling robots to perform a task). In some instances, a change of positions and orientations of the first and second devices may provide instructions for, e.g., an avatar to perform an action in a virtual world that may have or not a consequence in the real world. In some instances, a change of positions and orientations of the first and second devices may provide instructions for a robot to perform a task in the real world. For instance, the first device may present an environment, e.g., farmland, filmed by a first drone at a first altitude and the second device may present a portion of the environment filmed by a second drone at second altitude lower than the first altitude. The second device may control operation of the second drone, e.g., dispensing fertilizer, while presenting information to indicate, e.g., in real time, an operational parameter of the second drone, e.g., a fertilizer level. The first device may concomitantly present an area of the environment treated by the second drone, e.g., by highlighting, in real time, an outline of the area.

In some examples, metadata of multi-component media content (e.g., a multi-display media content) may include additional information to generate content, in between two displays of a multi-display arrangement, on a third display such as an AR display (e.g., AR head-mounted display or glasses). For example, a first device comprising a first display may present a first content depicting a pitcher, the second device comprising a second display may present a second content depicting a batter/catcher and the AR device comprising an AR display may present a ball as the ball travels from the first device to the second device. This allows for very immersive multiscreen and multi-perspective experiences. In order to perform the correct anchoring of content in the real world between the first and second displays, the AR device ought to receive the spatial features of the two-display arrangement as described in a previous section of this disclosure. The AR device may then derive the correct anchor point in the real world based on a detection of the first device and the second device in a field of view of the AR device. The supplemental content to be displayed “in transit” may be received by the AR device as the AR device is communicatively connected to the first display, second display or both.

In some examples, to ensure consistent perceived resolution across virtual and physical displays forming a plurality of displays, a display resolution (and thus requested bitrate representations) of one or more displays of the plurality of displays may be adjusted such that a user may observe similar values of pixels per degree (PPD) on the plurality of displays. The lowest available PPD of the plurality of displays, or any available resolution compatible with the plurality of displays may be selected.

In some examples, a position and orientation of a first device comprising a display may be tracked. Tracked position and orientation data of the first device may be processed alongside tracked position and orientation data of a second device comprising a display too. In some instances, the first device may be stationary as in most use cases (e.g., living-room TV, arena screen). Alternatively, the first device may be moving: use cases exist for movable displays as well, such as laptops or vehicle-based advertisements.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale.

The above and other objects and advantages of the disclosure may be apparent upon consideration of the following detailed description, taken in conjunction with the accompanying drawings, in which:

FIG. 1 shows an example for enabling the improved and coordinated presentation of a multi-component media content across multiple devices, in accordance with some implementations of the disclosure;

FIGS. 2A to 2E represent an example for enabling the improved and coordinated presentation of a multi-component media content across multiple devices, in accordance with some implementations of the disclosure;

FIG. 3 illustrates a flow diagram of illustrative steps involved in the improved and coordinated presentation of a multi-component media content across multiple devices, in accordance with some implementations of the disclosure;

FIG. 4 depicts a flow diagram of illustrative steps involved in the improved and coordinated presentation of a multi-component media content across multiple devices, in accordance with some implementations of the disclosure;

FIG. 5 shows a flow diagram of illustrative steps involved in the improved and coordinated presentation of a multi-component media content across multiple devices, in accordance with some implementations of the disclosure;

FIGS. 6A to 6B represents a flow diagram of illustrative steps involved in the improved and coordinated presentation of a multi-component media content across multiple devices, in accordance with some implementations of the disclosure;

FIG. 7 depicts an example for enabling the improved and coordinated presentation of a multi-component media content across multiple devices, in accordance with some implementations of the disclosure;

FIG. 8 shows a flow diagram of illustrative steps involved in the improved and coordinated presentation of a multi-component media content across multiple devices, in accordance with some implementations of the disclosure;

FIGS. 9A to 9C represent an example for enabling the improved and coordinated presentation of a multi-component media content across multiple devices, in accordance with some implementations of the disclosure;

FIGS. 10A to 10B illustrates an example for enabling the improved and coordinated presentation of a multi-component media content across multiple devices, in accordance with some implementations of the disclosure;

FIG. 11 depicts a flow diagram of illustrative steps involved in the improved and coordinated presentation of a multi-component media content across multiple devices, in accordance with some implementations of the disclosure;

FIG. 12 represents a block diagram showing components of an example system for enabling the improved and coordinated presentation of a multi-component media content across multiple devices;

FIGS. 13A to 13B illustrates different ways to characterize a distance between a first device and a second device configured to present a multi-component media content, in accordance with some implementations of the disclosure;

FIG. 14 depicts a flow diagram of illustrative steps involved in the improved and coordinated presentation of a multi-component media content across multiple devices, in accordance with some implementations of the disclosure; and

FIG. 15 shows a flow diagram of illustrative steps involved in the improved and coordinated presentation of a multi-component media content across multiple devices, in accordance with some implementations of the disclosure.

### DESCRIPTION

As referred to herein, the term ‘content item’ comprises an electronically consumable user asset, such as an electronic version of a printed book, electronic television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, blogs, advertisements, chat sessions, social media, applications, games, and/or any other media or multimedia and/or combination of the same.

As referred to herein, the term ‘content’comprises one or more content items.

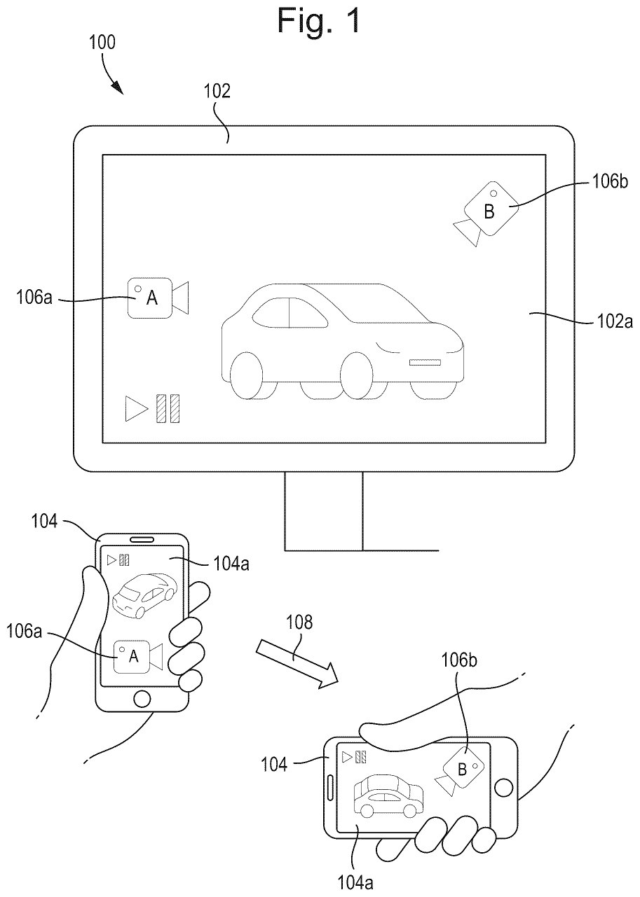

FIG. 1 shows an example system 100 for enabling the improved and coordinated presentation of a multi-component media content across multiple devices, in accordance with some implementations of the disclosure.

Example system 100 may comprise a first user device 102, a second user device 104, and a multi-component media content comprising a first content 102a and a second content 104a. First user device 102 may present first content 102a while second user device 104 may present second content 104a. First user device 102 may be a smart TV in a fixed position and orientation while second user device 104 may be a mobile phone whose position and orientation may be evolving upon user movement and manipulation. However, each of the first and second user devices 102, 104 may be any appropriate type of user devices configured to present, e.g., via video and/or audio, media content.

In some instances, the positions and orientations of the first and second user devices 102, 104 may be tracked, e.g., in real time, using one or more sensors integrated within the first and second user devices 102, 104, and/or separate from the first and second user devices 102, 104, e.g., sensors of another device. The tracked positions and orientations of the first and second user devices 102, 104 may then be used in a spatial map to determine a spatial relationship between the first and second user devices 102, 104. A dynamic synchronization parameter (which is discussed below in further detail) is then determined based on the tracked positions and orientations of the first and second user devices 102, 104, the dynamic synchronization parameter establishing a coherence between first content 102a and second content 104a. In some instances, the coherence between first content 102a and second content 104a may be temporal, spatial and/or content-oriented (e.g., based on a cause/consequence relationship). In the example shown in FIG. 1, the dynamic synchronization parameter establishes or defines an association between the relative position/orientation of the first and second user devices 102, 104, and various viewpoints (e.g., actual or virtual viewpoints, indicated by imaging device positions 106a and 106b) from which the second content 104a may be viewed on the second user device 104.

In the example shown in FIG. 1, multi-display media content comprises first content 102a and second content 104a that are associated with an advertisement promoting a car (although various types or media content are within scope of the disclosure). In some instances, consecutive frames associated with first content 102a may present a perspective of the car based on the position and orientation of the first user device 102 relative to the second user device 104. Similarly, the consecutive frames associated with second content 104a may present a perspective of the car based on the position and orientation of the second user device 104 relative to the first user device 102.

For the sake of clarity, the depiction of the first imaging device position 106a and the second imaging device position 106b is shown merely to indicate potential (e.g., available) viewpoints of the multi-display media content. For example, when superimposed on first content 102a, the first and second imaging depictions 106a and 106b indicate positions and orientations of the first and second imaging devices relative to the car, when capturing the car. When superimposed on second content 104a, first imaging device depiction 106a indicates that the respective perspective of the car captured by the first imaging device is being presented while the second imaging device depiction 106b indicates that the respective perspective of the car captured by the second imaging device is being presented.

When the position and orientation of the second user device 104 are changed, as expressed by arrow 108, from a first position/orientation to a second position/orientation, e.g., while the position and orientation of the first user device 102 do not change, second content 104a initially presenting a perspective view of the car associated with the first imaging device position 106a is modified to present a perspective of the car associated with the second imaging device position 106b. First content 104 may remain unaltered or may be modified, e.g., as discussed below in further detail. A link between the change of position/orientation of second user device 104 and the resulting change of second content 104a is embedded in the dynamic synchronization parameter.

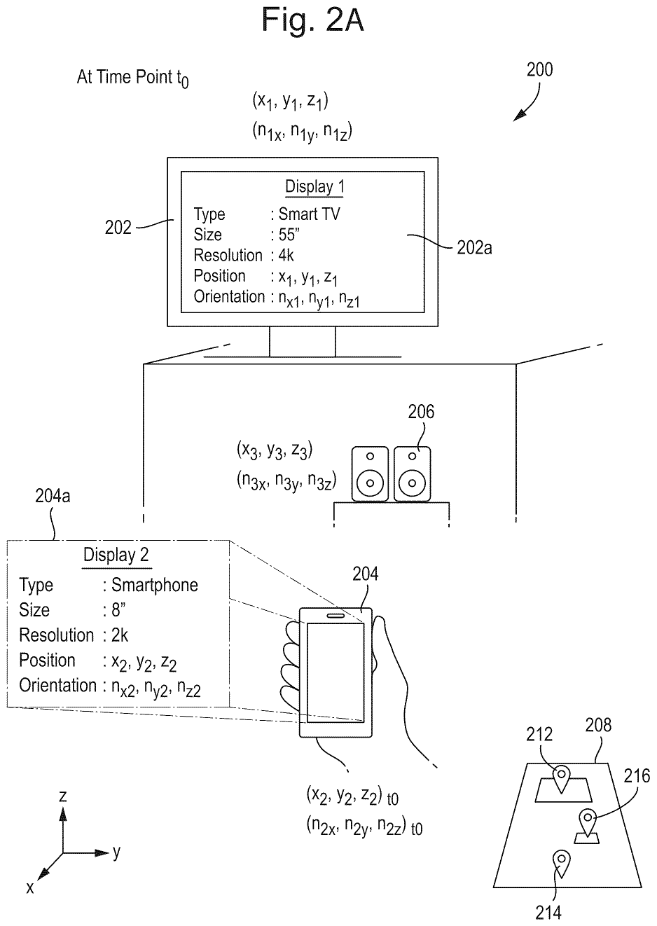

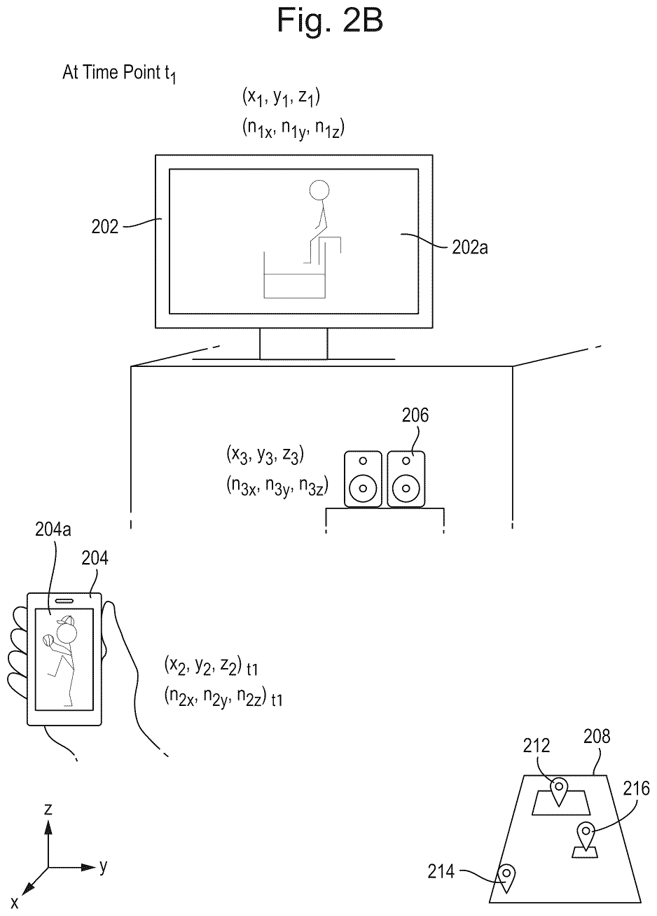

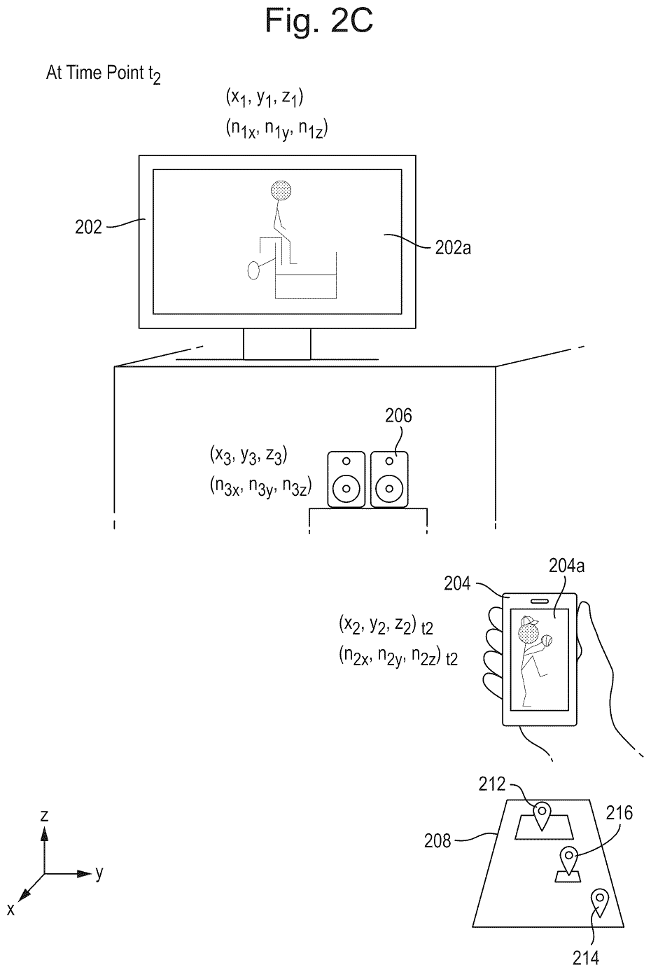

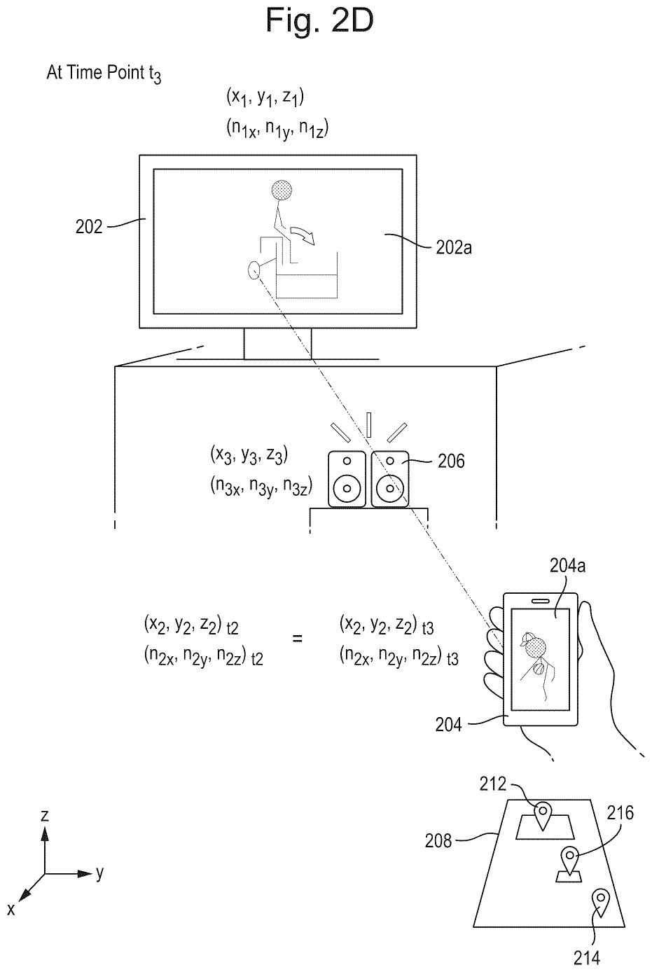

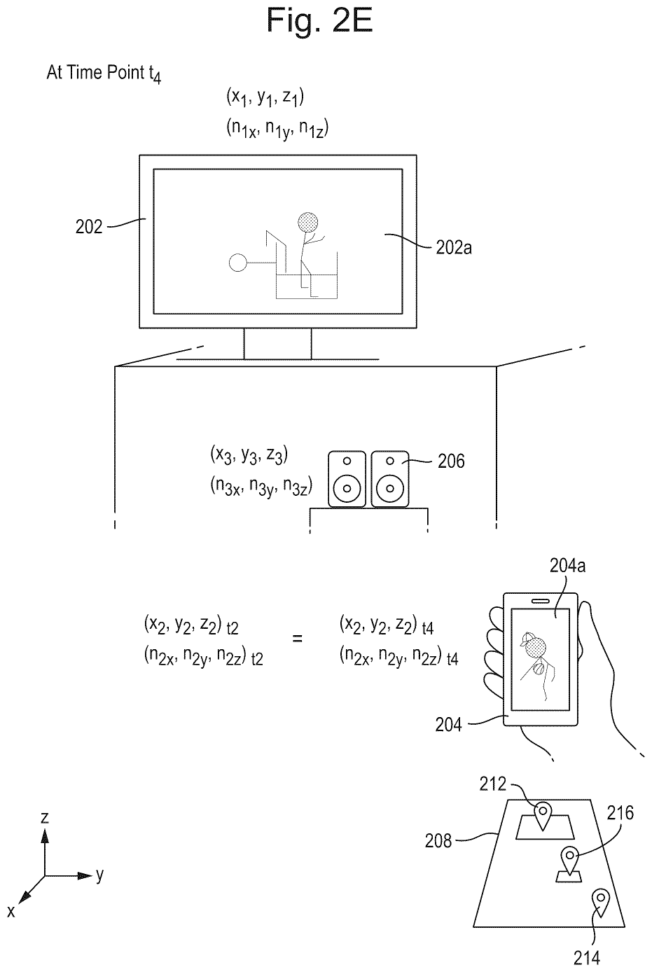

FIGS. 2A to 2E depict an example system 200, at a respective time point (e.g., t₀, t₁, t₂, t₃ and t₄ wherein t₄>t₃>t₂>t₁>t₀), for enabling the improved and coordinated output of a multiple-component media content (e.g., comprising a first content 202a and a second content 204a) across multiple devices (e.g., first user device 202, second user device 204 and speakers 206).

Example system 200 may comprise a first user device 202 (e.g., a smart TV, a computer, a laptop, a tablet, a mobile phone), a second user device 204 (e.g., a smart TV, a computer, a laptop, a tablet, a mobile phone) and a third user device 206 (e.g., speakers, sound bar), all located in a same room. In some examples, first user device 202, second user device 204 and third user device 206 may be a smart TV, a mobile phone and speakers, respectively. In some instances, first user device 202, second user device 204 and third user device 206 may be in communication with a server via a communication network (e.g., WAN and/or LAN). In some instances, first user device 202, second user device 204 and third user device 206 may be in communication via peer-to-peer communication protocol means (e.g., Bluetooth Low Energy, or Wi-Fi Direct). In some instances, a user carries second user device 204 in the same room and may change position within the same room. In some instances, a position and orientation of each user device (e.g., first user device 202, second user device 204 and third user device 206) located in the same room are monitored in real time, using internal sensors of each user device (when available) and/or external sensors (e.g., cameras) placed in the same room. The position and orientation of each user device obtained in real time are fed to, e.g., the server or one of first user device 202 and second user device 204, to generate for display a spatial map 208 comprising a depiction of the same room, and icons assigned to each user device. First user device 202, second user device 204 and third user device 206 may be assigned an icon 212, an icon 214, an icon 216, respectively. A position of an icon within spatial map 208 is mapped to a position of a user device (the icon is assigned to) in the same room such that spatial map 208 matches, in real time, the real world. This applies to each pair of icon/user device (e.g., icon 212/first user device 202, icon 214/second user device 204, icon 216/third user device 206). In some instances, icon 212, icon 214 and icon 216 may comprise information related to first user device 202, second user device 204 and third user device 206, respectively. In some instances, the related information may comprise features of the device (e.g., device type, display size, resolution, presentable sound frequency range, presentable sound intensity range, etc.), a real-time position of the device (e.g., real-time coordinates in a referential based on an x-axis, y-axis and z-axis), a real-time orientation of the device (e.g., real-time vector normal to a plane considered to represent the device, whose components on each of the x-axis, y-axis and z-axis indicate the real-time device orientation), one or more hyperlinks pertinent to the device (e.g., to access a webpage of a distributor or manufacturer of the device, a user manual of the device, a forum related to the device, etc.). In some instances, the related information may be accessible upon user interface input. In some instances, an application may control, upon user input and via a user profile, a presentation of the multi-component media content on first user device 202 and second user device 204, the user profile being associated with at least first user device 202 and second user device 204 (and possibly third user device 206). In some instances, the multi-component media content may comprise a first content 202a to be presented on first user device 202 and of a second content 204a to be presented on second user device 204. In some instances, spatial map 208 may be displayed, via the application, at first user device 202 or second user device 204 in order to be accessible to the user. The user can then position and orient second device 204 in the same room relative to first user device 202 so as to position icon 214 in spatial map 208 so as to purposely modify first content 202a and/or second content 204a.

In some instances, first user device 202 and third user device 206 may be stationary during a first period of time encompassing time points t₀, t₁, t₂ t₃ and t₄. The positions and orientations of first user device 202 and third user device 206 are thus constant during the first period of time. A position of first user device 202 may be expressed as, e.g., coordinates (x₁, y₁, z₁) of a center of gravity of first user device 202. First user device 202 may be assimilated to a first plane. The orientation of first user device 202 may be expressed as a first vector n₁ normal to the first plane, and having respective components on each of of x-axis, y-axis and z-axis so as to have the following coordinates (n₁ₓ, n_{1y}, n_{1z}). During the first period of time, the orientation of first user device 202 being constant, the direction of the first vector is constant and may be, for example, aligned with the x-axis. Similarly, during the first period of time, the position of third user device 206 may be expressed as, e.g., coordinates (x₃, y₃, z₃) of a center of gravity of third user device 202. During the first period of time, the orientation of third user device 206 may be expressed as the following coordinates (n₃ₓ, n_{3y}, n_{3z}) of a third vector n₃ may be constant.

In some instances, during the first period of time, second user device 204 may move (e.g., upon a user movement, the user carrying second user device 204) while the orientation of second user device 204 may be fixed. A position of second user device 204 may be expressed as, e.g., coordinates (x₂, y₂, z₂) of a center of gravity of second user device 204. For instance, second user device 204 may be assimilated to a second plane. The orientation of second user device 204 may be expressed as a second vector n₂ normal to the second plane, and having respective components on each of of x-axis, y-axis and z-axis so as to have the following coordinates (n₂ₓ, n_{2y}, n_{2z}). During the first period of time, the orientation of second user device 204 being constant, the direction of the second vector is constant and may be, for example, aligned with the x-axis.

At time point t₀ associated with FIG. 2A, first user device 202 (that is stationary) may be positioned in a room around a center of a background, the background being at a distance (e.g., a few meters) from the user. Second user device 204 (that can move, for example, along the y-axis) may be initially positioned in the room around a center of a foreground, the foreground representing the user's immediate surroundings. Third user device 206 (that is stationary) may be positioned in between first user device 202 and second user device 204, around a virtual line joining the foreground center and the background center. Spatial map 208 associated with time point t₀ accurately presents the positions of first user device 202, second user device 204 and third user device 206 via depictions of assigned icons 212, 214 and 216. At time point t₀, coordinates of first user device 202 are (x₁, y₁, z₁)ₜ₀ and coordinates of the first vector n₁ are (n₁ₓ, n_{1y}, n_{1z})ₜ₀. At time point t₀, coordinates of second user device 204 are (x₂, y₂, z₂)ₜ₀ and coordinates of the second vector n₂ are (n₂ₓ, n_{2y}, n_{2z})ₜ₀. At time point t₀, coordinates of third user device 206 are (x₃, y₃, z₃)ₜ₀ and coordinates of the third vector n₃ are (n₃ₓ, n_{3y}, n_{3z})ₜ₀. The coordinates of first user device 202 and third user device 206 are constant during the first period of time. Similarly, the coordinates of the first vector n₁ and the third vector n₃ are constant during the first period of time.

At time point t₀ associated with FIG. 2A, first user device 202 may present first content 202a depicting a list of information (e.g., technical features such as type and display size of first user device 202; real-time position; real-time orientation) associated with first user device 202. Similarly, second user device 204 may present second content 204a depicting a list of information (e.g., technical features such as type and display size of second user device 204; real-time position; real-time orientation) associated with second user device 204. Third user device 206 may not emit any acoustic signal.

At time point t₁ associated with FIG. 2B, second user device 204 may shift, along the y-axis, towards the negative ‘y’ values (or the left in FIG. 2B) close to a border of the same room. At time point t₁, the coordinates of second user device 204 are (x₂, y₂, z₂)ₜ₁ and the coordinates of the second vector n₂ are (n₂ₓ, n_{2y}, n_{2z})ₜ₁. This change of position is accurately reflected in spatial map 208. In some instances, first content 202a presented on first user device 202 and second content 204a presented on second user device 204 may be portions of different content. In some instances, first content 202a presents a to-be-dunked character placed on a seat above a carnival dunk tank comprising a target configured to actuate a tilting of the seat when hit by a ball (the target being not shown in FIG. 2B). In first content 202a, all limbs of the to-be-dunked character are all as if they were oriented towards the negative ‘y’ values too. Second content 204a presents a pitcher ready to throw a ball. In first content 202a, the pitcher's posture is such that their right hand holds the ball and their right arm is positioned behind their body to impart momentum to the ball while their left leg is raised, folded and turned inward to face their abdomen. All limbs of the pitcher are as if they were oriented towards the negative ‘y’ values. First content 202a and second content 204a are as if first content 202a and second content 204a were to be artificially portions of a same content and as if an artificial target had been captured by a notional imaging device. The pitcher and the to-be-dunked character seating above the carnival dunk tank remain more or less at the same place due to their respective role, and thus occupy respective positions in the artificial target. First content 202a presented on first user device 202 reflects which perspective of the to-be-dunked character seating above the carnival dunk tank would capture a notional imaging device placed at a position around the artificial target associated with a position, in the real world, of second user device 204 relative to the fixed position of first user device 202. Similarly, second content 204a presented on second user device 204 reflects which perspective of the pitcher would capture the notional imaging device placed at the position around the artificial target associated with the position, in the real world, of second user device 204 relative to the fixed position of first user device 202. Accordingly, when second user device 204 shifts along the y-axis, the notional imaging device captures different perspectives of the pitcher and to-be-dunked character seating above the carnival dunk tank which are presented on first user device 202 and second user device 204, respectively.

At time point t₂ associated with FIG. 2C, second user device 204 may shift, along the y-axis, towards the positive ‘y’ values (or the right in FIG. 2C) close to another border of the same room. At time point t₂, the coordinates of second user device 204 are (x₂, y₂, z₂)ₜ₂ and the coordinates of the second vector n₂ are (n₂ₓ, n_{2y}, n_{2z})ₜ₂. This change of position is accurately reflected in spatial map 208. The position of each device (e.g., first user device 202, second user device 204 and third user device 206) is accurately depicted in spatial map 208. First content 202a presents a different perspective of the to-be-dunked character as emphasized by the grey color of the character head, the different perspective being captured by the notional imaging device whose position in the artificial target is associated with the new position of second user device 204 relative to the fixed position of first user device 202. All limbs of the to-be-dunked character are as if they were oriented towards the positive ‘y’ values. Additionally, the target actuating the tilting of the seat of the carnival dunk tank is depicted in first content 202a. Second content 204a presents a different perspective of the pitcher as emphasized by the grey color of the character head, the different perspective being captured by the notional imaging device whose position around the artificial target associated with the new position of second user device 204 relative to the fixed position of first user device 202. In second content 204a, all limbs of the pitcher are all as if they were oriented towards the positive ‘y’ values.

At time point t₃ associated with FIG. 2D, second user device 204 remains at the same position as the position associated with time point t₂. At time point t₃, the coordinates of second user device 204 are thus (x₂, y₂, z₂)ₜ₂ and the coordinates of the second vector n₂ are (n₂ₓ, n_{2y}, n_{2z})ₜ₂. The position of each device (e.g., first user device 202, second user device 204 and third user device 206) is accurately depicted in spatial map 208. The pitcher has already launched the ball towards the target of the carnival dunk tank. Consequently, second content 204a presents the pitcher having launched the ball. In some instances, first content 202a and/or second content 204a may comprise the ball. Alternatively, the ball may be generated by instructions of a non-transitory computer-readable medium to superimpose graphic information (e.g., writing and/or drawing) upon the first content and/or second content. A virtual trajectory of the ball is materialized by a segment 210 that starts at a point of a casing of second user device 204 and ends at a point of the target presented in first content 202a. Segment 210 passes through third device 206. In some instances, the virtual trajectory of the ball may follow the laws of physics of the real world such that a duration for the ball to travel segment 210 is coherent with a distance of segment 210 and a speed of the ball imparted by the pitcher. First content 202a still presents the to-be-dunked character seating above the carnival dunk tank. In some instances, the virtual trajectory of the ball may follow artificial laws of an imaginary world.

As a result of the virtual trajectory of the ball passing through third device 206, third device 206 generates, from a start point of segment 210 to an end point of segment 210, an acoustic signal to mimic a sound of the ball travelling from the pitcher's hand to the target of the carnival dunk tank. Characteristics (e.g., duration, time-dependent intensity, time-dependent source point) of the acoustic signal associated with the virtual trajectory of the ball may follow the laws of physics of the real world such that the user would perceive the acoustic signal as if the acoustic signal were to be generated, in the real world, by a ball launched by a pitcher. In some instances, the acoustic signal may mimic other sounds than a ball launched by a pitcher, such as a missile travelling to reach a target. In some instances, third device 206 may modulate an intensity of the acoustic signal and/or a virtual position of a source of the acoustic signal so as to materialize, in an auditory way, the virtual trajectory of the ball as depicted by segment 210 in FIG. 2D or any other virtual trajectory of the ball between the start point of segment 210 and the end point of segment 210. For instance, the pitcher could impart some effect in the ball such that the virtual trajectory of the ball is not anymore entirely straight but could include some curved portions.

At time point t₄ associated with FIG. 2E, second user device 204 remains at the same position as the position associated with time point t₂ (or the position associated with time point t₃). At time point t₄, the coordinates of second user device 204 are thus (x₂, y₂, z₂)ₜ₂ and the coordinates of vector n₂ are (n₂ₓ, n_{2y}, n_{2z})ₜ₂. The position of each device (e.g., first user device 202, second user device 204 and third user device 206) is accurately depicted in spatial map 208. First content 202a presents the to-be-dunked character in the tank while second content 204a still presents the pitcher having launched the ball. In effect, second content 204a had been paused to save some network bandwidth resources.

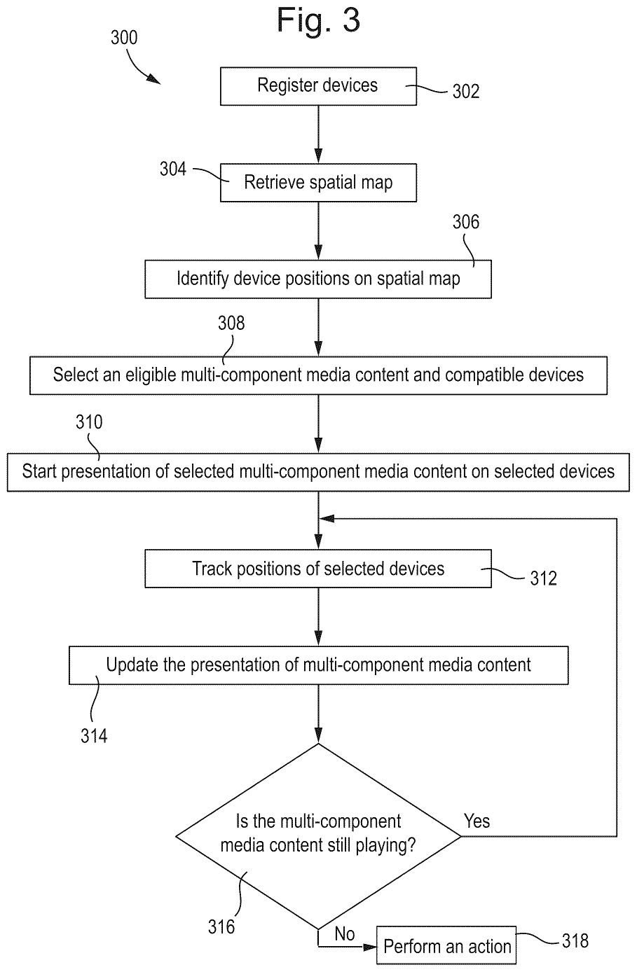

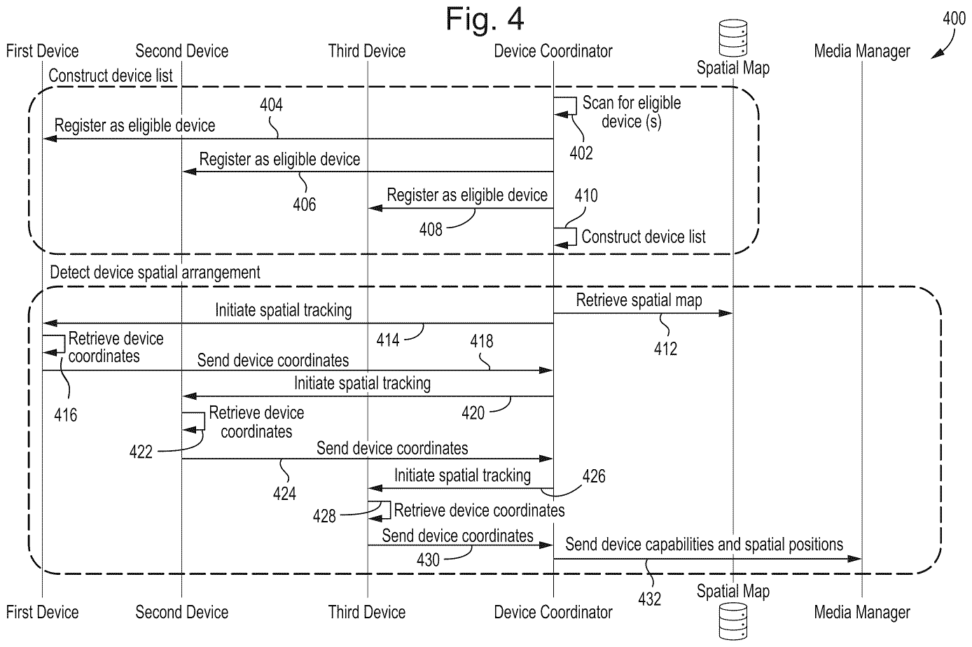

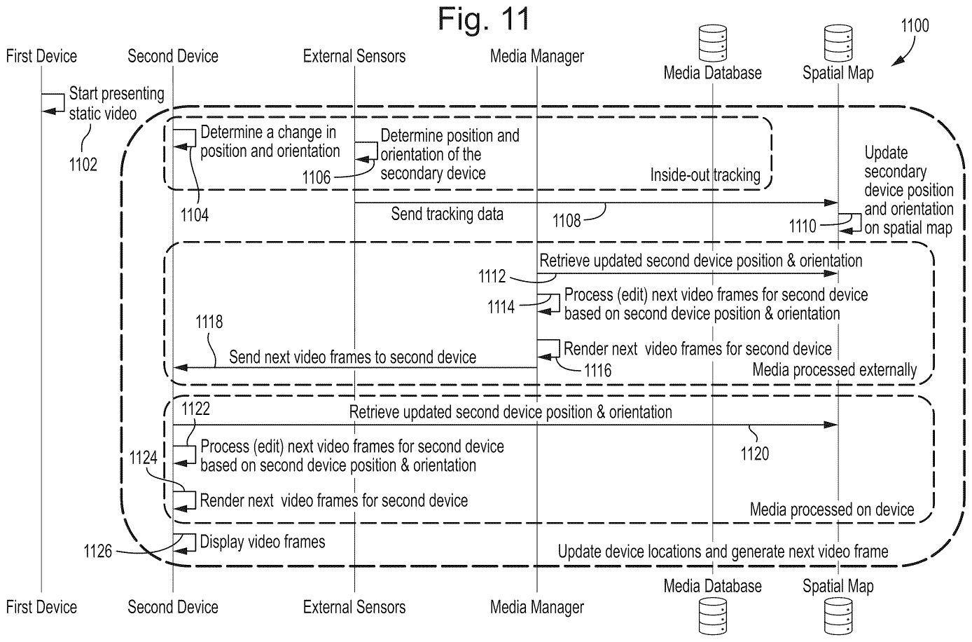

FIG. 3 illustrates a flow diagram 300 of illustrative steps involved in the improved and coordinated presentation of a multi-component media content across multiple devices, in accordance with some implementations of the disclosure. Illustrative steps of flow diagram 300 may be performed by control circuitry of a device, wherein the device may be a server (e.g., a device coordinator depicted in FIGS. 4, 5, 6A and 6B, a media manager depicted in FIGS. 4, 5, 6A, 6B and 11, or a server configured to generate spatial map depicted in FIGS. 4 and 11). Alternatively, the device may be a user device (e.g., first user device 102, 202, 902, 1002, second user device 104, 204, 904, 1004, or third user device 106).

At step 302, control circuitry of the device, may register nearby devices (e.g., user devices such as first user device 102, 202, 902, 1002, second user device 104, 204, 904, 1004, or third user device 106). In some instances, the control circuitry of the device may access a list of nearby devices, wherein the list of nearby devices may have been established by a smart home service (e.g., Google Home® or Apple Home®). Alternatively, the control circuitry of the device may dynamically populate the list of nearby devices by determining devices connected to a same communication network (e.g., Wi-Fi network) as the device establishing the list of nearby devices. Subsequently, the control circuitry of the device may analyze the list of nearby devices to only register the nearby devices configured to present a multi-component media content. Additionally, the control circuitry of the device may use a peer-to-peer communication protocol (e.g., Bluetooth Low Energy (BLE) and Wi-Fi Direct) to only register the nearby devices that are sufficiently close to each other to be used to present each a first content or a second content from the multi-component media content. The control circuitry of the device may proceed to step 304.

At step 304, the control circuitry of the device may retrieve a spatial map (e.g., spatial map 208, 908, 1008), from, e.g., a smart home service, a smart home device such as an autonomous robot (e.g., robot vacuum cleaner), or a XR device (e.g., Apple Vision Pro®). Alternatively, the control circuitry of the device may generate the spatial map using one or more imaging devices located in a same room as the registered nearby user devices, or integrated in the device itself. The control circuitry of the device may then proceed to step 306.

At step 306, the control circuitry of the device may identify positions of the registered devices on the spatial map. The control circuitry of the device may then proceed to step 308.

At step 308, the control circuitry of the device may select an eligible multi-component media content (e.g., a multi-component media content comprising a first content such as first content 102a, 202a, 902a, 1002a, a second content such as second content 104a, 204a, 904a, 1004a) and compatible devices from the registered devices. In some instances, the control circuitry of the device may determine the best match (e.g., in terms of resolution) between multiple sets of two registered devices and a multi-component media content set so as to optimize a rendering of a multi-component media content by two registered devices. A resolution of the multi-component media content may be UHD while all set of two registered devices may be only able to present a media content of resolution equal to 4K or below. Necessarily, another multi-component media content of resolution equal to 4K will be selected. The control circuitry of the device may then proceed to step 310.

At step 310, the control circuitry of the device may start a presentation of selected multi-component media content on two selected devices. In some instances, the control circuitry of the device may present a presentation of a first content (e.g., first content 102a, 202a, 902a, 1002a) on one of the two or three registered devices (e.g., first user device 102, 202, 902, 1002, second user device 104, 204, 904, 1004, third user device 106) and a presentation of a second content (e.g., first content 104a, 204a, 904a, 1004a) on the other one. The control circuitry of the device may then proceed to step 312.

At step 312, the control circuitry of the device may track positions of selected devices, e.g., using position data provided by one or more internal sensors (e.g., an accelerometer, a geomagnetic field sensor, a gyroscopic sensor and LIDAR-based sensor) of the two selected devices, and/or one or more external sensors (e.g., a camera) located in a same room as the two selected devices. In some instances, the control circuitry of the device may determine the relative positions and orientations of the two registered devices so as to select the first content to be presented on one of the two selected devices and the second content to be presented on the other one. In some instances, the first content may present a first perspective of a same target (e.g., a location where an event occurs, that may involve, for example, a character or an object performing an action) and the second content may present a second perspective of the same target. In some instances, the same target may be an artificial target or a real target. In the artificial target, the first content and the second content are portions of different content while in the real target, the first content and the second content are portions of a same content. For instance, the real target is imaged by a plurality of cameras arranged around the same target. For instance, the artificial target cannot be imaged by a plurality of cameras arranged around the same target. In the artificial target, the first content and second content are as if first content and second content were to be artificially portions of a same content. The control circuitry of the device may then proceed to step 314.

At step 314, the control circuitry of the device may update the presentation of the selected multi-component media content, e.g., based on the tracked positions of the two registered devices. In some instances, the control circuitry of the device may update the first content presented on one of the two registered devices and the second content presented on the other one, by updating the first perspective by a third perspective and the second perspective by a fourth perspective. The control circuitry of the device may then proceed to step 316.

At step 316, the control circuitry of the device may determine whether the multi-component media content is still being presented. If so, the control circuitry of the device may revert to step 312. If not, the control circuitry of the device may then proceed to step 318.

At step 318, the control circuitry may perform an action, e.g., put to sleep the two registered devices, or search for another multi-component media content to be presented on the two registered devices.

FIG. 4 depicts a flow diagram 400 of illustrative steps involved in the improved and coordinated presentation of a multi-component media content across multiple devices, in accordance with some implementations of the disclosure. In some instances, flow diagram 400 may relate to determining the multiple devices that are eligible to present a multi-component media content and a spatial arrangement the multiple devices. Additionally, flow diagram 400 may relate to selecting a subset of the multiple devices based on device positions and capabilities and a multi-component media content based on device capabilities.

In some instances, each of a device coordinator, a media manager, a device configured to generate a spatial map and a media database may be a server or a user device (e.g., a device of the multiple devices that are eligible to present a multi-component media content, such as first user device 102, 202, 902, 1002, second user device 104, 204, 904, 1004, or third user device 106). In some instances, a same device may comprise the device coordinator, the media manager, the device configured to generate a spatial map and the media database, the same device being a server or a user device (e.g., a device of the multiple devices that are eligible to present a multi-component media content, such as first user device 102, 202, 902, 1002, second user device 104, 204, 904, 1004, or third user device 106).

At step 402, control circuitry of the device coordinator may scan for one or more eligible devices, for example, connected to a same communication network. Alternatively, the control circuitry of a device coordinator may perform API calls to a smart home service to retrieve additional eligible devices. The control circuitry of the device coordinator may then proceed to step 404.

At step 404, the control circuitry of the device coordinator may register a first device (e.g., a device of the multiple devices that are eligible to present a multi-component media content, such as first user device 102, 202, 902, 1002, second user device 104, 204, 904, 1004, or third user device 106) as an eligible device if the first device is configured to participate in a presentation of a multi-component media content. The control circuitry of the device coordinator may then proceed to step 406.

At step 406, the control circuitry of the device coordinator may register a second device (e.g., a device of the multiple devices that are eligible to present a multi-component media content, such as first user device 102, 202, 902, 1002, second user device 104, 204, 904, 1004, or third user device 106) as an eligible device if the second device is configured to participate in a presentation of a multi-component media content. The control circuitry of the device coordinator may then proceed to step 408.

At step 408, the control circuitry of the device coordinator may register a third device (e.g., a device of the multiple devices that are eligible to present a multi-component media content, such as first user device 102, 202, 902, 1002, second user device 104, 204, 904, 1004, or third user device 106) as an eligible device if the third device is configured to participate in a presentation of a multi-component media content. The control circuitry of the device coordinator may then proceed to step 410.

At step 410, the control circuitry of the device coordinator may establish a list comprising the registered one or more eligible devices. The control circuitry of the device coordinator may then proceed to step 412.

At step 412, the control circuitry of the device coordinator may retrieve a spatial map from a smart home service (e.g., Google Home® or Apple Home®), a smart home device such as an autonomous robot (e.g., robot vacuum cleaner), or a XR device (e.g., Apple Vision Pro®). The control circuitry of the device coordinator may then proceed to step 414.

At step 414, the control circuitry of the device coordinator may initiate spatial tracking of the first device using internal sensors (e.g., location sensors integrated in the first device such as e.g., an accelerometer, a geomagnetic field sensor, a gyroscopic sensor and LIDAR-based sensor). Additionally or alternatively, the control circuitry of the device coordinator may initiate spatial tracking of the first device using at least one external sensor (e.g., camera located in the same location as the first, second and third devices). The control circuitry of the device coordinator may then proceed to step 420 if control circuitry of the first device has performed steps 416 and 418.

At step 416, the control circuitry of the first device may retrieve location data (e.g., position and orientation in a referential based on an x-axis, y-axis and z-axis) from internal sensors. The control circuitry of the first device may then proceed to step 418.

At step 418, the control circuitry of the first device may deliver the location data to the device coordinator.

At step 420, the control circuitry of the device coordinator may initiate tracking of the second device using internal sensors (e.g., location sensors integrated in the second device e.g., an accelerometer, a geomagnetic field sensor, a gyroscopic sensor and LIDAR-based sensor). Additionally or alternatively, the control circuitry of the device coordinator may initiate tracking of the second device using at least one external sensor (e.g., camera located in the same location as the first, second and third devices). The control circuitry of the device coordinator may then proceed to step 426 if control circuitry of the second device has performed steps 422 and 424.

At step 422, the control circuitry of the second device may retrieve location data (e.g., position and orientation in a referential based on an x-axis, y-axis and z-axis) from internal sensors. The control circuitry of the second device may then proceed to step 424.

At step 424, the control circuitry of the second device may deliver the location data to the device coordinator.

At step 426, the control circuitry of the device coordinator may initiate spatial tracking of the third device using internal sensors (e.g., location sensors integrated in the second device e.g., an accelerometer, a geomagnetic field sensor, a gyroscopic sensor and LIDAR-based sensor). Additionally or alternatively, the control circuitry of the device coordinator may initiate spatial tracking of the third device using at least one external sensor (e.g., camera located in the same location as the first, second and third devices). The control circuitry of the device coordinator may then proceed to step 432 if control circuitry of the third device has performed steps 428 and 430.

At step 428, the control circuitry of the third device may retrieve location data (e.g., position and orientation in a referential based on an x-axis, y-axis and z-axis) from internal sensors.

At step 430, the control circuitry of the third device may deliver the location data to the device coordinator.

At step 432, the control circuitry of the device coordinator may send technical capabilities and location data of the first, second and third devices to a media manager in order for the media manager to select a multi-component media content compatible with the technical capabilities of first, second and third devices and optimize a rendering of the to-be-selected multi-component media content. The technical capabilities may comprise static information such as device features and hardware capabilities (e.g., speakers, display, spatial tracking) as well as dynamic information such as device position, battery life, or speaker volume. Additionally, the technical capabilities may comprise dynamic information updatable at a static refresh rate, based on device features such as battery life, or based on triggers such as the appearance of a new eligible device or a rapid change of speed of a device. Once a list of eligible devices has been constructed and location data (e.g., position and orientation in a referential based on an x-axis, y-axis and z-axis) of eligible devices are being regularly updated, a list of potential multi-component media content that could be presented is retrieved.

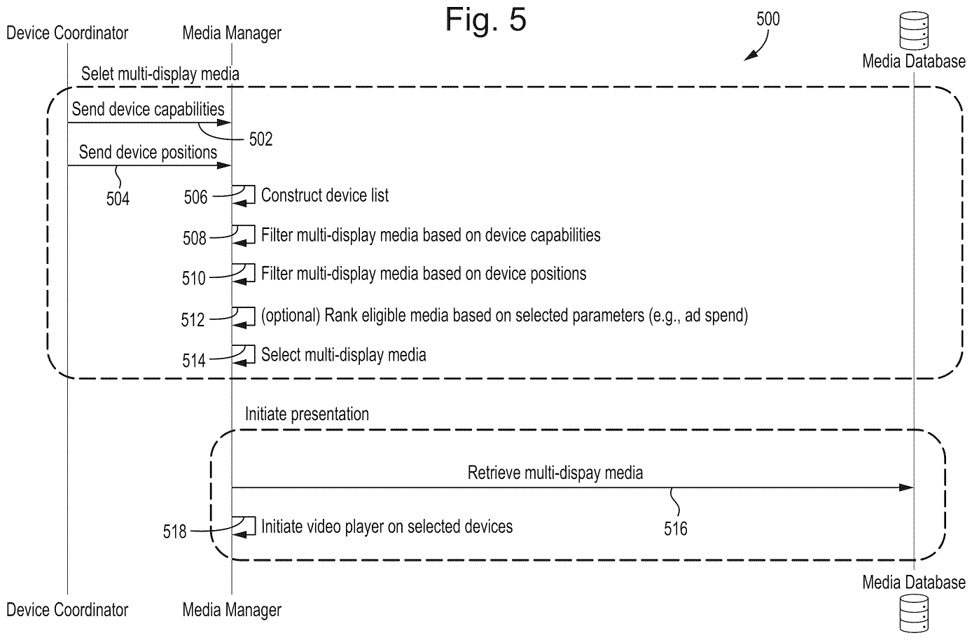

FIG. 5 shows a flow diagram 500 of illustrative steps involved in the improved and coordinated presentation of a multi-component media content across multiple devices, in accordance with some implementations of the disclosure. In some instances, flow diagram 500 may relate to selecting a multi-component media content and initiating a presentation of a selected multi-component media content.

In some instances, each of a device coordinator, a media manager, a device configured to generate a spatial map and a media database may be a server or a user device (e.g., a device of the multiple devices that are eligible to present a multi-component media content, such as first user device 102, 202, 902, 1002, second user device 104, 204, 904, 1004, or third user device 106). In some instances, a same device may comprise the device coordinator, the media manager, the device configured to generate a spatial map and the media database, the same device being a server or a user device (e.g., a device of the multiple devices that are eligible to present a multi-component media content, such as first user device 102, 202, 902, 1002, second user device 104, 204, 904, 1004, or third user device 106).

At step 502, control circuitry of a device coordinator may send technical capabilities of one or more devices (of the multiple devices that are eligible to present a multi-component media content) to a media manager. The control circuitry of the device coordinator may then proceed to step 504.

At step 504, the control circuitry of the device coordinator may send location data (e.g., position and orientation in a referential based on an x-axis, y-axis and z-axis) of the one or more devices to the media manager.

At step 506, control circuitry of the media manager may establish a list of the one or more devices. The control circuitry of the media manager may then proceed to step 508.

At step 508, the control circuitry of the media manager may filter a set of multi-component media content based on technical capabilities of the one or more devices. In some instances, the set of multi-component media content may be filtered based on features such as the number of the one or more devices, the position of the one or more devices, and the available hardware capabilities of the one or more devices. For example, a visual multi-display ad may simply require two displays of any kind, while a visual and audio multi-display ad may require a smartphone, a TV, and a speaker. The control circuitry of the media manager may then proceed to step 510.

At step 510, the control circuitry of the media manager may filter the one or more devices based on device positions. The control circuitry of the media manager may then proceed to step 512.

At step 512, the control circuitry of the media manager may rank the set of multi-component media content based on selected parameters (e.g., ad spend). The control circuitry of the media manager may then proceed to step 514.

At step 514, the control circuitry of the media manager may select a multi-component media content. In some instances, the control circuitry of the media manager may select a multi-component media content, e.g., based on the ranking of the set of multi-component media content. Requirements for a multi-component media content may include the presence as well as the quality or accuracy of particular features. For example, a multi-component media content comprising an ad may require perspective-based features such as a FOV taken up by a display, and it may specify that those features are only eligible at certain confidence level or below a level of variability in a sliding window. The control circuitry of the media manager may then proceed to step 516.

At step 516, the control circuitry of the media manager may retrieve the multi-component media content. Additionally, the control circuitry of the media manager may select multiple devices among the filtered one or more devices. The control circuitry of the media manager may then proceed to step 518.

At step 518, the control circuitry of the media manager may initiate a presentation of the multi-component media content on the selected devices (e.g., following flowchart 400).

In some instances, selecting a multi-component media content may proceed in the following manner. A first device may present, to a user, a first content comprising at least a portion of a first perspective associated with a soccer match. In some instances, a second device may be detected, e.g., by communication between the devices or otherwise, within a distance from the first device below a threshold distance. A user interface may prompt a user to launch a search for a second content. The user interface may identify the second content and present a description of the second content. In some instances, the second content may comprise at least a portion of a second perspective associated with the soccer match, the second perspective being different from the first perspective. The user interface may then prompt the user to present the second content on the second device.

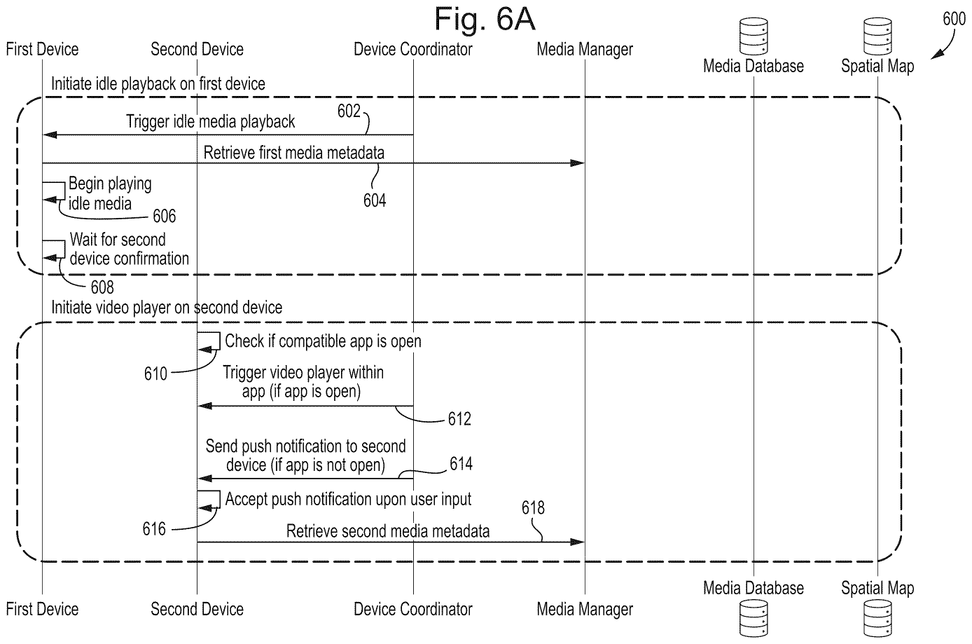

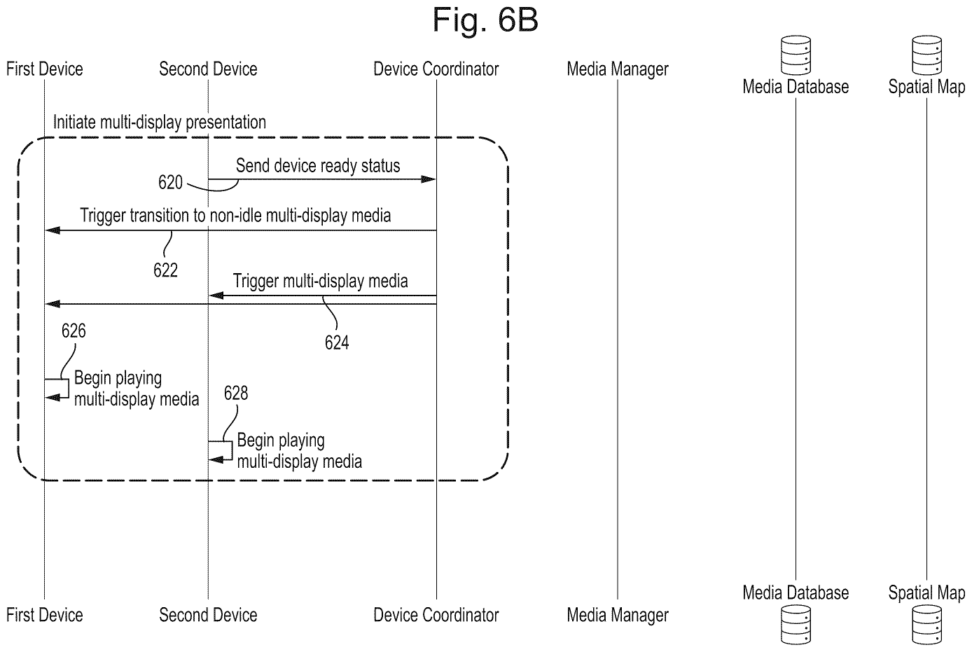

FIGS. 6A to 6B represents a flow diagram 600 of illustrative steps involved in the improved and coordinated presentation of a multi-component media content across multiple devices, in accordance with some implementations of the disclosure. In some instances, flow diagram 600 may relate to initiating idle presentation, on a first device, of a first content of a multi-component media content, initiating a presenter (e.g., a video player) to present, on a second device, a second content of the multi-component media content, and initiating a multi-component media content.

In some instances, each of a device coordinator, a media manager, a device configured to generate a spatial map and a media database may be a server or a user device (e.g., a device of the multiple devices that are eligible to present a multi-component media content, such as first user device 102, 202, 902, 1002, second user device 104, 204, 904, 1004, or third user device 106). In some instances, a same device may comprise the device coordinator, the media manager, the device configured to generate a spatial map and the media database, the same device being a server or a user device (e.g., a device of the multiple devices that are eligible to present a multi-component media content, such as first user device 102, 202, 902, 1002, second user device 104, 204, 904, 1004, or third user device 106).

In some instances, the multiple devices may comprise a first device (e.g., first device 102, 202, 902 or 1002) and a second device (e.g., second device 104, 204, 904 or 1004). In some instances, the multi-component media content may comprise a first content (e.g., first content 102a, 202a, 902a or 1002a) for presentation on the first device and a second content (e.g., 104a, 204a, 904a or 1004a) for presentation on the second device (e.g., second device 104, 204, 904 or 1004).

At step 602, control circuitry of the device coordinator may trigger, at the first device, an idle presentation of a multi-component media content, which is associated with an idle presentation mode. In some instances, during the idle presentation mode, an ad may be presented on first device and/or second device. In some instances, the control circuitry of the device coordinator may proceed, e.g., when steps 604 to 610 have been performed, to step 612 or step 614.

At step 604, control circuitry of a first device may retrieve, from the media manager, a manifest associated with the multi-component media content, one or more frames (or segments) of the first content and metadata associated with the one or more frames (or segments) of the first content. The manifest may comprise information associated with the first content and second content of the multi-component media content. In some instances, the control circuitry of the first device may retrieve, from the media manager, one or more frames (or segments) associated with a first ad. In some instances, the control circuitry of the first device may then proceed to step 606.

At step 606, the control circuitry of the first device may start the idle presentation, of the multi-component media content, e.g., by presenting on the first device using a first presenter (e.g., a video player) of a first app, the one or more frames (or segments) of the first content. In some instances, the idle presentation of the multi-component media content may comprise a presentation, on the first device, of the one or more frames (or segments) of the first content. For example, a start frame or short clip of the first content may be presented in loop during at least a part of a duration of the idle presentation mode. In some instances, the control circuitry of the first device may start the idle presentation of the multi-component media content, for example, by presenting on the first device using the first presenter of the first app, the one or more frames (or segments) associated with the first ad along with the one or more frames (or segments) of the first content. In some instances, the control circuitry of the first device may start the idle presentation of the multi-component media content, for example, by presenting on the first device using the first presenter of the first app, the one or more frames (or segments) associated with the first ad, prior to presenting on the first device the one or more frames (or segments) of the first content. In some instances, the idle presentation of the multi-component media content may comprise a presentation, on the first device, of the one or more frames (or segments) associated with the first ad. For example, a single frame or sequence of frames associated with the first ad may be presented during at least a part of the duration of the idle presentation mode, wherein the single frame may comprise a logo and/or a motto associated with a brand. In some instances, the control circuitry of the first device may send, during the idle presentation of the multi-component media content, a request to another nearby device such as the second device, to participate in the idle presentation of the multi-component media content, for example, if the second device is sufficiently close to the first device. For example, the second device may be sufficiently close to the first device when first and second devices are able to communicate via a peer-to-peer communication protocol such as Bluetooth Low Energy or Wi-Fi Direct. In some instances, the control circuitry of the first device may then proceed to step 608.

At step 608, the control circuitry of the first device may wait for a confirmation, from the second device, to participate in the idle presentation of the multi-component media content while presenting the one or more frames (or segments) of the first content and/or the one or more frames (or segments) associated with the first ad. In some instances, the control circuitry of the first device may proceed to step 626, e.g., when steps 610 to 612 and 618 to 624 have been performed or when steps 610, 614 to 624 have been performed.

At step 610, control circuitry of a second device may determine, e.g., upon a receipt of the request, from the first device, to participate in the idle presentation of the multi-component media content, whether a second app, that is compatible with the first app for presenting the multi-component media content such that the first content and second content are presented on the first and second devices, respectively, is open. In some instances, the second app may be same as or different from the first app. In some instances, the control circuitry of the second device may proceed to step 616, e.g., when steps 602 to 610 and 614 have been performed. In some instances, the control circuitry of the second device may proceed to step 618, e.g., when steps 602 to 612 have been performed.

At step 612, the control circuitry of the device coordinator may trigger a second presenter (e.g., a video player) within the second app if the second app is open. In some instances, the control circuitry of the device coordinator may proceed to step 622, e.g., when steps 618 to 620 have been performed.

At step 614, the control circuitry of the device coordinator may send a push notification to the second device if the second app is not open. In some instances, the control circuitry of the device coordinator may proceed to step 622, e.g., when steps 616 to 620 have been performed.

At step 616, the control circuitry of the second device may accept the push notification upon a user interface input. In some instances, the control circuitry of the second device may proceed to step 618.

At step 618, the control circuitry of the second device may retrieve, from the media manager, one or more frames (or segments) of the second content and metadata associated with the one or more frames (or segments) of the second content. In some instances, the control circuitry of the second device may retrieve, from the media manager, one or more frames (or segments) associated with a second ad. In some instances, the control circuitry of the second device may proceed to step 620.

At step 620, the control circuitry of the second device may send a ready status to the device coordinator. In some instances, the control circuitry of the second device may proceed to step 628.

At step 622, the control circuitry of the device coordinator may trigger a transition from the idle presentation mode to an active presentation mode. In some instances, the control circuitry of the device coordinator may send a push notification to the second device to present the one or more frames (or segments) of the second content and/or the one or more frames (or segments) associated with a second ad. In some instances, the transition may comprise a presentation, on the second device, of the one or more frames (or segments) of the second content. For example, a start frame or short clip of the first content may be presented in loop during at least a part of a duration of the transition. In some instances, the transition may comprise a presentation, on the second device, of one or more frames (or segments) associated with a second ad. For example, a single frame or sequence of frames associated with the second ad may be presented during at least a part of the duration of transition, wherein the single frame may comprise a logo and/or a motto associated with a brand. In some instances, the second ad may be same as or different from the first ad. In some instances, the control circuitry of the device coordinator may proceed to step 624.

At step 624, the control circuitry of the device coordinator may trigger, e.g., upon an end of the transition, a presentation of the first content on the first device and a presentation of the second content on the second device.

At step 626, the control circuitry of the first device may start presenting the first content of the multi-component media content, e.g., by requesting from the media manager and presenting, a sequence of segments of the first content.

At step 628, the control circuitry of the second device may start presenting the second content of the multi-component media content, e.g., by requesting from the media manager and presenting, a sequence of segments of the second content. In some instances, the control circuitry of the second device may start presenting the second content item, e.g., after the control circuitry of the first device has presented a respective frame of the first content.

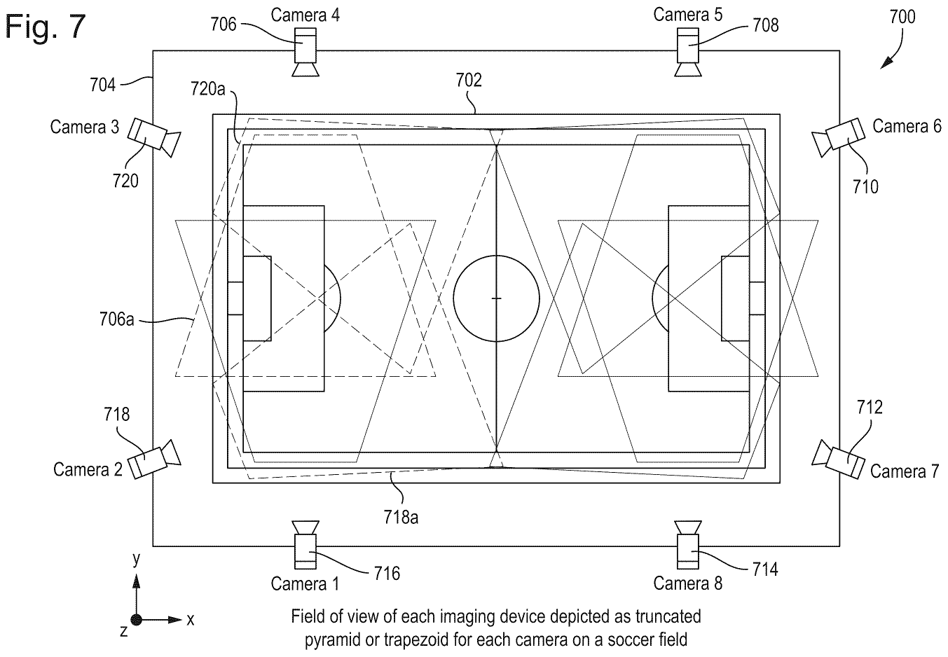

FIG. 7 depicts an example system 700 for enabling the improved and coordinated presentation of a multi-component media content across multiple devices, in accordance with some implementations of the disclosure.

Example system 700 may comprise a plurality of imaging devices (e.g., cameras 706 to 720) arranged on a perimeter of a rectangle 704 surrounding a same target (e.g., a location where an event occurs, that may involve, for example, a character or an object performing an action) such as a soccer field 702 in order to capture different FOVs associated with the same target and generate corresponding perspectives associated with the same target. In some instances, positions and orientations of the plurality of imaging devices may remain constant in a referential based on an x-axis, y-axis and z-axis, over time, and are also known at all times: there is a thus a spatial relationship between each imaging device that translates as a known spatial relationship between bitstreams originating from each of the imaging devices. An orientation of each imaging device is expressed as a respective vector normal to a respective sensor area of the each imaging device, the respective vector having respective components on each of of x-axis, y-axis and z-axis. Each imaging device captures a FOV depicted as a trapezoid (e.g., trapezoid 706a, trapezoid 708a, trapezoid 720a, which are depicted in dashed lines to emphasize their presence—the rest of the trapezoids are simply depicted in plain lines but are not labelled for the sake of clarity) and thus generate a respective perspective of soccer field 702. Each imaging device generates a respective content item representing a respective perspective of soccer field 702 over time. Furthermore, there is a spatial relationship between each respective content item based on the spatial relationship between each imaging device. For instance, a plurality of respective content items representing each a respective perspective of soccer field 702 may be used as a multi-component media content that can be presented on multiple devices (e.g., two devices).

In some instances, the plurality of respective content items may be recorded, stored in a server, and delivered, when requested by multiple devices (e.g., user devices such as first user device 102, 202, 902, 1002, second user device 104, 204, 904, 1004, or third user device 106) via a communication network, to at least one of the multiple devices, as encoded segments of a multi-component media content, using, for example, an ABR streaming technique such as MPEG-DASH. After requesting the multi-component media content, a manifest associated with the multi-component media content is delivered to the at least one of the multiple devices (e.g., a DASH user device) via HTTP, email, thumb drive, broadcast, or other transports. The manifest (e.g., media presentation description) may comprise a list of the plurality of respective content items of the multi-component media content, URL address of each respective content item, information related to segments of each respective content item (e.g., CODEC used to compress each portion of each respective content item into a segment, time duration of each segment, position of each segment in a segment sequence corresponding to a respective content item, content description of each segment, resolution of each segment, network bandwidth resource to be consumed to deliver each segment, etc.), positions and orientations of the imaging devices in the referential based on the x-axis, y-axis and z-axis. associated with each respective content item, etc. The at least one of the multiple devices may parse the manifest and determine the multi-component media content timing, availability, types, resolutions, minimum and maximum bandwidths to achieve multiple-component media content delivery, and the plurality of respective content items of the multi-component media content and possibly alternatives of the respective content items of the plurality of respective content items (such as a respective content item comprising different audio streams based on different languages), accessibility features, required digital rights management (DRM), locations of the plurality of respective content items on the network, and other content characteristics. Based on information from the manifest, the at least one of multiple devices may select appropriate encoded respective content items of the multi-component media content and start streaming the selected respective content items of the multi-component media content by fetching segments associated with the selected respective content items using e.g., HTTP GET requests.

Alternatively, based on information from the manifest, the server may select appropriate encoded respective content items of the multi-component media content and start streaming the selected respective content items of the multi-component media content by delivering segments associated with the selected respective content items to the at least one of the multiple devices. The manifest may thus provide adequate information to the at least one of the multiple devices or the server for selecting and switching between streams associated each with a respective content item of the plurality of respective of content items. In some instances, the multiple devices may thus simultaneously present (depending upon relative positions and orientations of the multiple devices) each a respective content item presenting at least a portion of a respective perspective of the same target (e.g., soccer field 702). In some instances, the multiple devices may thus simultaneously present (depending upon relative positions and orientations of the multiple devices) each a content from a same content item, the content presenting at least a respective portion of a same perspective of the same target. In some instances, the multiple devices may thus simultaneously present (depending upon relative positions and orientations of the multiple devices) each a content from a same content item, the content presenting at least a same portion of a same perspective of the same target.

In some instances, the server or the at least one of the multiple devices may determine a first spatial relationship between the multiple devices based on information (e.g., positions, orientations) associated with the multiple devices. The server or the at least one of the multiple devices may then determine, from the manifest, the imaging devices whose second spatial relationship corresponds the best match to the first relationship. The multi-component media content comprises a first content and a second content. The server or the at least one of the multiple devices may then request the simultaneous presentation of first content on a first device of the multiple devices and second content on a second device of the multiple devices, the first content and second content being respective perspectives of the soccer field 702 captured by the imaging devices exhibiting the second spatial relationship.

In some instances, a respective perspective captured by an imaging device may be mapped to a position and orientation of the imaging device in the referential based on the x-axis, y-axis and z-axis. A manifest file may contain the information relating to the mapping. In some instances, a respective perspective captured by an imaging device may be augmented using a supplemental content with which the respective perspective is associated, to add the stadium view and stand view, or decreased by cropping the respective perspective. In some instances, respective perspectives may be ranked based on the user-dependent importance or saliency of the respective perspectives. A user may pre-select respective perspectives to be presented. For instance, the server or the at least one of the multiple devices determines that a first device may present a respective perspective from camera 706 while a second device may present a respective perspective from camera 708.

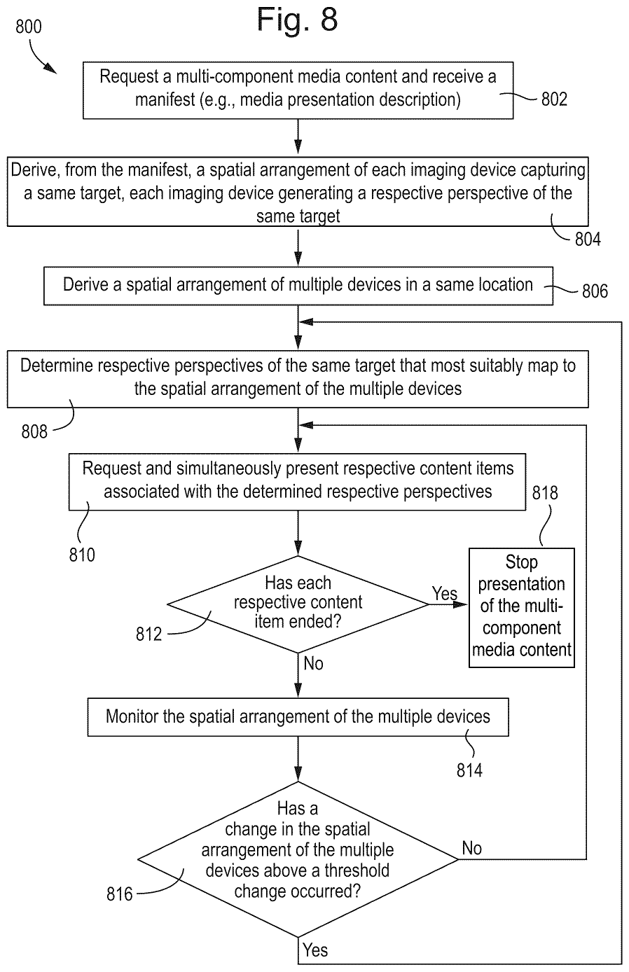

FIG. 8 shows a flow diagram 800 of illustrative steps involved in the improved and coordinated presentation of a multi-component media content across multiple devices, in accordance with some implementations of the disclosure. Illustrative steps of flow diagram 800 may be performed by control circuitry of a device, wherein the device may be a server (e.g., a device coordinator depicted in FIGS. 4, 5, 6A and 6B, a media manager depicted in FIGS. 4, 5, 6A, 6B and 11, or a server configured to generate spatial map depicted in FIGS. 4 and 11). Alternatively, the device may be a user device (e.g., first user device 102, 202, 902, 1002, second user device 104, 204, 904, 1004, or third user device 106).

At step 802, the control circuitry of the device may request a multi-component media content and receive a manifest (e.g., media presentation description). The control circuitry of the device may then proceed to step 804.

At step 804, the control circuitry of the device may derive, from the manifest, a spatial arrangement of each imaging device (e.g., camera) capturing a same target (e.g., a location where an event occurs, that may involve, for example, a character or an object performing an action), each imaging device generating a respective perspective of the same target. In some instances, the control circuitry of the device may associate an imaging device of fixed position and orientation with a respective content item, each respective content item presenting at least a portion of a respective perspective of the same target (e.g., soccer field 702). The control circuitry of the device may then proceed to step 806.

At step 806, the control circuitry of the device may derive a spatial arrangement of multiple devices in a same location. The control circuitry of the device may then proceed to step 808.

At step 808, the control circuitry of the device may determine respective perspectives of the same target corresponding to imaging devices whose spatial arrangement most suitably maps to the spatial arrangement of the multiple devices. The control circuitry of the device may proceed to step 810.

At step 810, the control circuitry of the device may request respective content items (of the multi-component media content) associated with the determined respective perspectives of the same target, and a simultaneous presentation of the respective content items on the multiple devices, e.g., such that each respective content item is presented on a respective device of the multiple devices. In some instances, each of the multiple devices may present at least a portion of a determined respective perspective of the same target. In some instances, each of the multiple devices may present at least a portion of a same determined perspective of the same target. In some instances, each of the multiple devices may present a same at least a portion of a same determined perspective of the same target. The control circuitry of the device may proceed to step 812.

At step 812, the control circuitry of the device may determine whether each respective content item has ended. If so, the control circuitry of the device may proceed to step 818 and stop the simultaneous presentation of the respective content items. In some instances, the control circuitry of the device may additionally search for another multi-component media content to present. If not, the control circuitry of the device may proceed to step 814.

At step 814, the control circuitry of the device may monitor the spatial arrangement of the multiple devices, e.g., by determining positions and orientations of the multiple devices. The control circuitry of the device may proceed to step 816.

At step 816, the control circuitry of the device may determine whether a change in the spatial arrangement of the multiple devices above a threshold change has occurred. If not, the control circuitry of the device may revert to step 810. If so, the control circuitry of the device may revert to step 808.

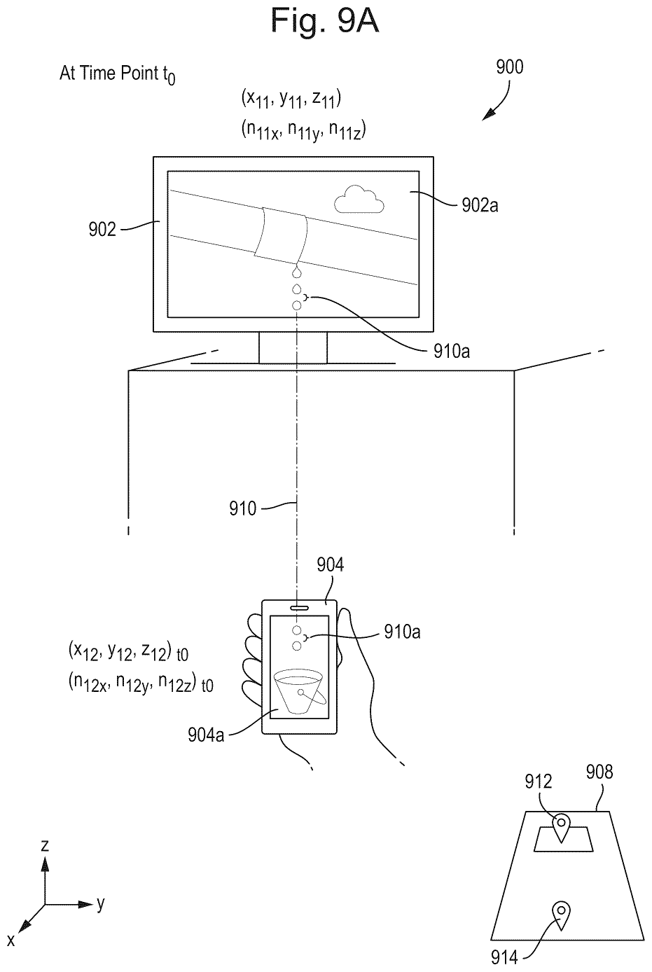

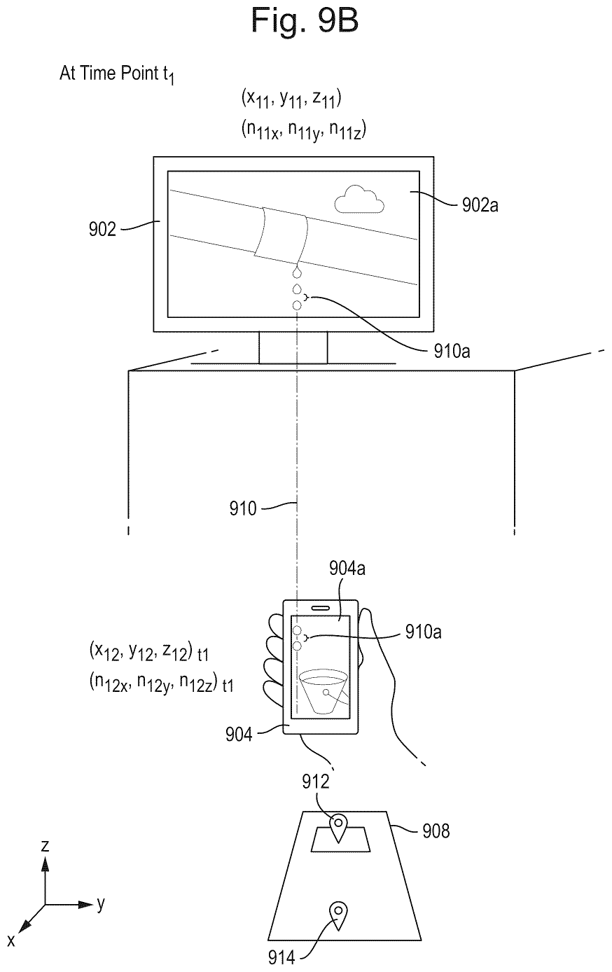

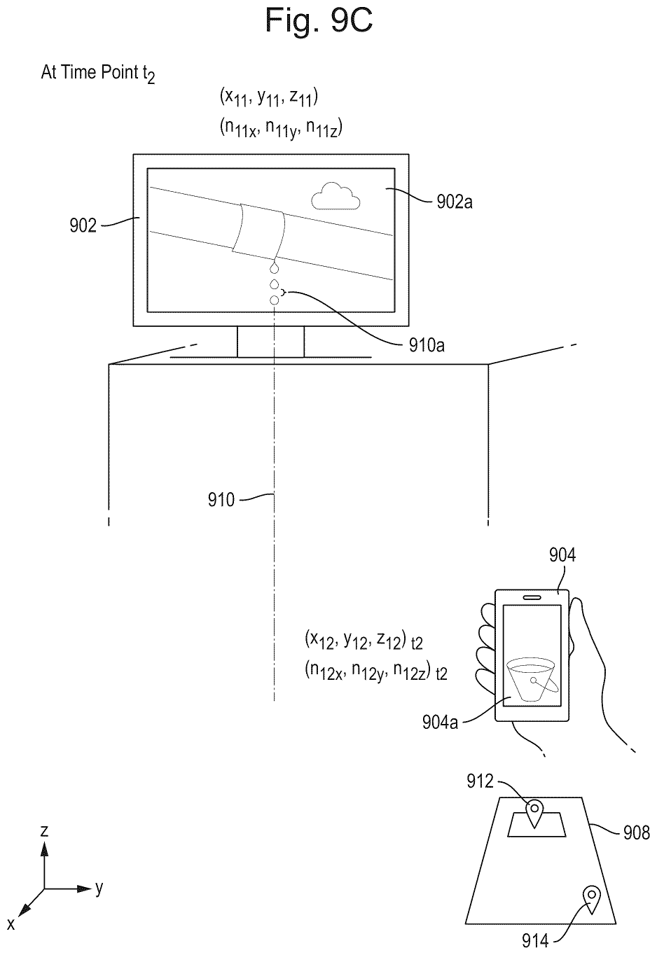

FIGS. 9A to 9C represent an example system 900, at a respective time point (e.g., t₀, t₁, and t₂ wherein t₂>t1₁>t₀), for enabling the improved and coordinated presentation of a multi-component media content (e.g., comprising a first content 902 and a second content 904) across multiple devices (e.g., first user device 902, second user device 904), in accordance with some implementations of the disclosure. In some instances, FIGS. 9A to 9C refer to ‘First Case’ as shown below.

Example system 900 may comprise a first user device 902 (e.g., a smart TV, a computer, a laptop, a tablet, a mobile phone) and a second user device 904 (e.g., a smart TV, a computer, a laptop, a tablet, a mobile phone), both located in a same room. In some examples, first user device 902, second user device 904 may be a smart TV and a mobile phone, respectively. In some instances, first user device 902 and second user device 904 may be in communication with a server via a communication network (e.g., WAN and/or LAN). In some instances, first user device 902 and second user device 904 may be in communication via peer-to-peer communication protocol means (e.g., Bluetooth Low Energy, or Wi-Fi Direct). In some instances, a user carries second user device 904 in the same room and may change position within the same room. In some instances, a position and orientation of each user device (e.g., first user device 902, second user device 904) located in the same room are monitored in real time, using internal sensors of each user device (when available) and/or external sensors (e.g., cameras) placed in the same room. The position and orientation of each user device obtained in real time are fed to, e.g., the server or one of first user device 902 and second user device 904, to generate for display a spatial map 908 comprising a depiction of the same room, and icons assigned to each user device. First user device 902 and second user device 904 may be assigned an icon 912 and an icon 914, respectively. A position of an icon within spatial map 908 is mapped to a position of a user device (the icon is assigned to) in the same room such that spatial map 908 matches, in real time, the real world. This applies to each pair of icon/user device (e.g., icon 912/first user device 902, icon 914/second user device 904). In some instances, icon 912 and icon 914 may comprise information related to first user device 902 and second user device 904, respectively. In some instances, the related information may comprise features of the device (e.g., device type, display size, resolution, presentable sound frequency range, presentable sound intensity range, etc.), a real-time position of the device (e.g., real-time coordinates in a referential based on an x-axis, y-axis and z-axis), a real-time orientation of the device (e.g., real-time vector normal to a plane considered to represent the device, whose components on each of the x-axis, y-axis and z-axis indicate the real-time device orientation), one or more hyperlinks pertinent to the device (e.g., to access a webpage of a distributor or manufacturer of the device, a user manual of the device, a forum related to the device, etc.). In some instances, the related information may be accessible upon user interface input. In some instances, an application may control, upon user input and via a user profile, a presentation of the multi-component media content on first user device 902 and second user device 904, the user profile being associated with at least first user device 902 and second user device 904. In some instances, the multi-component media content may comprise a first content 902a to be presented on first user device 902 and of a second content 904a to be presented on second user device 904. In some instances, spatial map 908 may be displayed, via the application, at first user device 902 or second user device 904 in order to be accessible to the user. The user can then position and orient second device 904 in the same room relative to first user device 902 so as to position icon 914 in spatial map 908 so as to purposely modify first content 902a and/or second content 904a.

In some instances, first user device 902 may be stationary during a first period of time encompassing time points t₀, t₁ and t₂. The position and orientation of first user device 902 are thus constant during the first period of time. A position of first user device 902 may be expressed as, e.g., coordinates (x₁₁, y₁₁, z₁₁) of a center of gravity of first user device 902. First user device 902 may be assimilated to a first plane. The orientation of first user device 902 may be expressed as an eleventh vector n₁₁ normal to the first plane, and having respective components on each of of x-axis, y-axis and z-axis so as to have the following coordinates (n₁₁ₓ, n_{11y}, n_{11z}). During the first period of time, the orientation of first user device 902 being constant, the direction of the eleventh vector n₁₁ is constant and may be, for example, aligned with the x-axis.

In some instances, during the first period of time, second user device 904 may move (e.g., upon a user movement, the user carrying second user device 904) while the orientation of second user device 904 may be fixed. A position of second user device 904 may be expressed as, e.g., coordinates (x₁₂, y₁₂, z₁₂) of a center of gravity of second user device 904. For instance, second user device 904 may be assimilated to a second plane. The orientation of second user device 904 may be expressed as a twelfth vector n₁₂ normal to the second plane, and having respective components on each of of x-axis, y-axis and z-axis so as to have the following coordinates (n₁₂ₓ, n_{12y}, n_{12z}). During the first period of time, the orientation of second user device 904 being constant, the direction of the twelfth vector n₁₂ is constant and may be, for example, aligned with the x-axis.

At time point t₀ associated with FIG. 9A, first user device 902 (that is stationary) may be positioned in a room around a center of a background, the background being at a distance (e.g., a few meters) from the user. Second user device 904 (that can move, for example, along the y-axis) may be initially positioned in the room around a center of a foreground, the foreground representing the user's immediate surroundings. Spatial map 908 associated with time point t₀ accurately presents the positions of first user device 902 and second user device 904 via the depictions of assigned icons 912 and 914. At time point t₀, coordinates of first user device 902 are (x₁₁, y₁₁, z₁₁)ₜ₀ and coordinates of the eleventh vector n₁₁ are (n₁₁ₓ, n_{11y}, n_{11z})ₜ₀. At time point t₀, coordinates of second user device 904 are (x₁₂, y₁₂, z₁₂)ₜ₀ and coordinates of the twelfth vector n₁₂ are (n₁₂ₓ, n_{12y}, n_{12z})ₜ₀.

### First Case

At time point t₀ associated with FIG. 9A, first user device 902 may present first content 902a associated with first user device 902, wherein first content 902a may depict a gutter leaking such that water droplets are falling from the gutter. Similarly, second user device 904 may present second content 904a associated with second user device 904, wherein second content 904a may depict water droplets falling into a bucket whose water level raises over time, as if the falling water droplets depicted in first content 902a were to become the falling water droplets depicted in second content 904a, as indicated by segment 910. In some instances, first content 902a presented on first user device 902 and second content 904a presented on second user device 904 may be portions of different content. A first dynamic synchronization parameter may define a first coherence between first content 902a and second content 904a. For instance, there is a same gap 910a between two consecutive water droplets depicted in first content 902a and second content 904a. Each water droplet travels a distance between first user device 902 and second user device 904 in a time defined by Newton's laws of motion which states that a sum of forces (e.g., weight and drag force) exerted on the water droplet equals to a product of a water droplet mass by a water droplet acceleration. Alternatively, each water droplet may travel a distance between first user device 902 and second user device 904 based on artificial laws of an imaginary world.

### Second Case

In some instances, first user device 902 may present first content 902a associated with first user device 902, wherein first content 902a may depict a gutter. Similarly, second user device 904 may present second content 904a associated with second user device 904, wherein second content 904a may depict an empty bucket. In some instances, first content 902a presented on first user device 902 and second content 904a presented on second user device 904 may be portions of different content. Water droplets may be virtually generated on both first content 902a and second content 904, based on instructions of a non-transitory computer-readable medium that superimpose graphic information (e.g., writing and/or drawing) upon both first content 902a and second content 904a such that falling water droplets from first content 902a become falling water droplets in second content 904a. Each water droplet travels a distance between first user device 902 and second user device 904 in a time defined by Newton's laws of motion which states that a sum of forces (e.g., weight and drag force) exerted on the water droplet equals to a product of a water droplet mass by a water droplet acceleration. Alternatively, each water droplet may travel a distance between first user device 902 and second user device 904 based on artificial laws of an imaginary world. A second dynamic synchronization parameter may thus define a second coherence between first content 902a and second content 904.

### Third Case

In some instances, first user device 902 may present first content 902a associated with first user device 902, wherein first content 902a may depict a gutter leaking such that water droplets are falling from the gutter. Similarly, second user device 904 may present second content 904a associated with second user device 904, wherein second content 904a may depict water droplets falling into a bucket whose water level raises over time, as if the falling water droplets depicted in first content 902a were to become the falling water droplets depicted in second content 904a. Additionally, first content 902a presented on first user device 902 and second content 904a presented on second user device 904 may be portions of a same content. In some instances, first content 902a and second content 904a may be extracted from the same frames of a same content item. A third dynamic synchronization parameter may define a third coherence between first content 902a and second content 904a.

### Fourth Case

In some instances, first user device 902 may present first content 902a associated with first user device 902, wherein first content 902a may depict a gutter leaking such that water droplets are falling from the gutter. Similarly, second user device 904 may present second content 904a associated with second user device 904, wherein second content 904a an empty bucket. Additionally, first content 902a presented on first user device 902 and second content 904a presented on second user device 904 may be portions of different content. Water droplets may be virtually generated on second content 904, based on instructions of a non-transitory computer-readable medium that superimpose graphic information (e.g., writing and/or drawing) upon second content 904a such that falling water droplets from first content 902a become falling water droplets in second content 904a. Each water droplet travels a distance between first user device 902 and second user device 904 in a time defined by Newton's laws of motion which states that a sum of forces (e.g., weight and drag force) exerted on the water droplet equals to a product of a water droplet mass by a water droplet acceleration. Alternatively, each water droplet may travel a distance between first user device 902 and second user device 904 based on artificial laws of an imaginary world. A fourth dynamic synchronization parameter may thus define a fourth coherence between first content 902a and second content 904a.

At time point t₁ associated with FIG. 9B, (considering First Case assumptions) second user device 904 may slightly shift, along the y-axis, towards the positive ‘y’ values (or the right in FIG. 9B). At time point t₁, the coordinates of second user device 904 are (x₁₂, y₁₂, z₁₂)ₜ₁ and the coordinates of the twelfth vector n₁₂ are (n₁₂ₓ, n_{12y}, n_{12z})ₜ₁. This change of position is accurately reflected in spatial map 908. The position of each device (e.g., first user device 902 and second user device 904) is accurately depicted in spatial map 908. In some instances, first content 902a presented on first user device 902 presents a leaking gutter from which water droplets fall following segment 910, and second content 904a presented on second user device 904 presents falling water droplets corresponding to falling water droplets from first content 904a that will land outside the bucket such that a water level within the bucket will remain constant. The first dynamic synchronization parameter may define an updated first coherence between first content 902a and second content 904a. For instance, there is a same gap 910a between two consecutive water droplets in first content 902a and second content 904a. Each water droplet travels a distance between first user device 902 and second user device 904 in a time defined by Newton's laws of motion which states that a sum of forces (e.g., weight and drag force) exerted on the water droplet equals to a product of a water droplet mass by a water droplet acceleration. Alternatively, each water droplet may travel a distance between first user device 902 and second user device 904 based on artificial laws of an imaginary world. Additionally, the first dynamic synchronization parameter may take into the fact that the water droplets land outside the bucket and the water level in the bucket does not change. Both events are associated with a respective second version of a plurality of second versions of second content 904a.

At time point t₂ associated with FIG. 9C, (considering First Case assumptions) second user device 904 may shift, along the y-axis, towards the positive ‘y’ values (or the right in FIG. 9C) close to another border of the same room. At time point t₂, the coordinates of second user device 204 are (x₂, y₂, z₂)ₜ₂ and the coordinates of vector n₂ are (n₂ₓ, n_{2y}, n_{2z})ₜ₂. This change of position is accurately reflected in spatial map 208. The position of each device (e.g., first user device 902 and second user device 904) is accurately depicted in spatial map 908. In some instances, first content 902a presented on first user device 902 presents a leaking gutter from which water droplets fall following the segment 910 and second content 904a presented on second user device 904 presents an empty bucket. Second content 904 does not present water droplets as second user device 904 is outside a trajectory of water droplets materialized by segment 910. The bucket will remain empty unless second user device is shifted to coincide with segment 910. The first dynamic synchronization parameter may define an updated first coherence between first content 902a and second content 904a. For instance, no water droplets from first content 902a is to reach second content 904a such that second content 904a is not affected by first content 902a. This event is associated with a respective second version of a plurality of second versions of second content 904a.

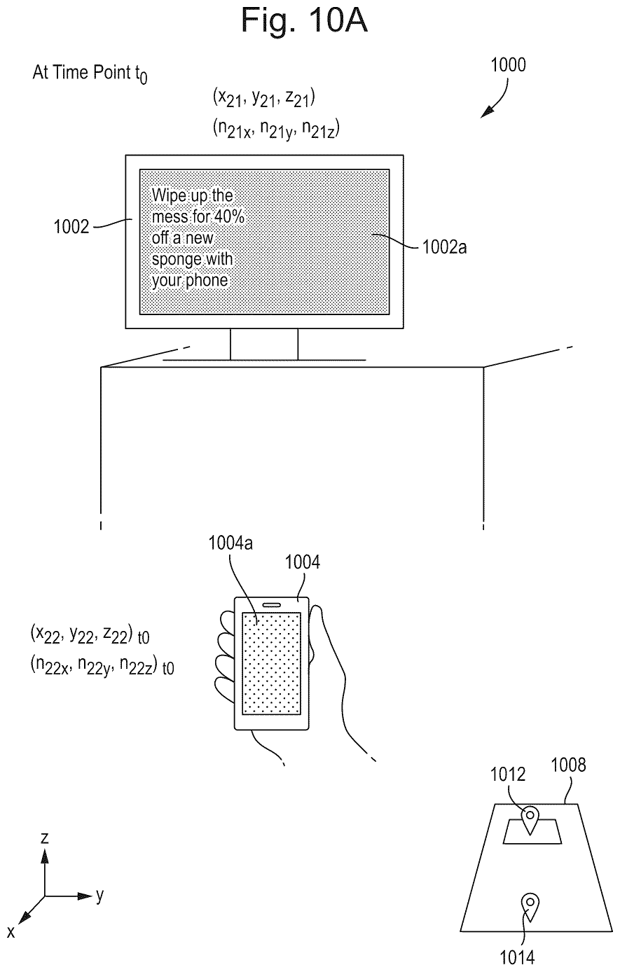

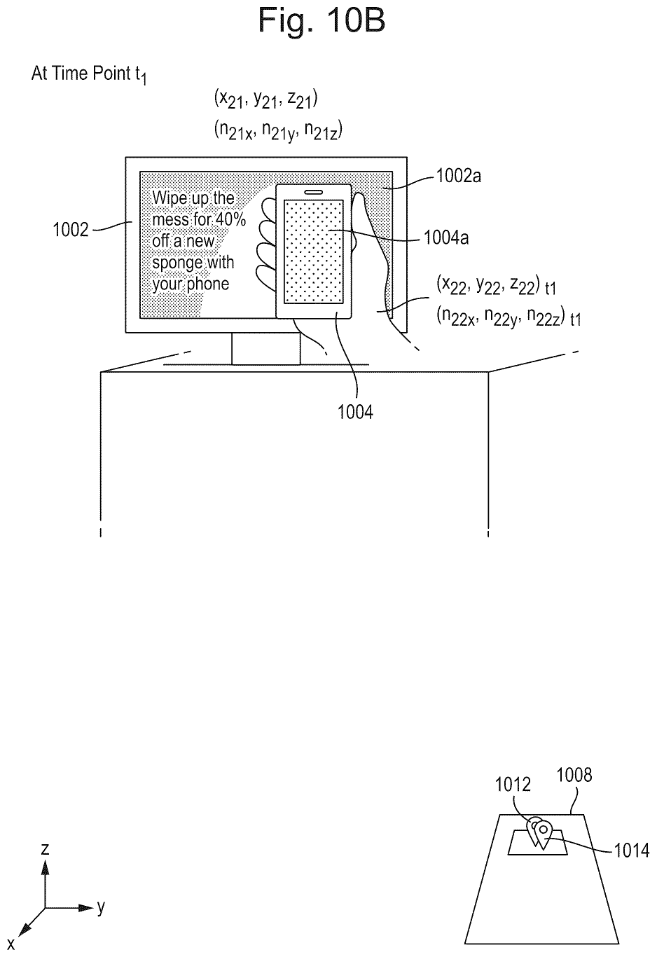

FIGS. 10A to 10B illustrates an example system 1000, at a respective time point (e.g., t₀ and t₁, wherein t₁>t₀), for enabling the improved and coordinated presentation of a multi-component media content (e.g., comprising a first content 902 and a second content 904) across multiple devices (e.g., first user device 902, second user device 904), in accordance with some implementations of the disclosure.

Example system 1000 may comprise a first user device 1002 (e.g., a smart TV, a computer, a laptop, a tablet, a mobile phone) and a second user device 1004 (e.g., a smart TV, a computer, a laptop, a tablet, a mobile phone), both located in a same room. In some examples, first user device 1002, second user device 1004 may be a smart TV and a mobile phone, respectively. In some instances, first user device 1002 and second user device 1004 may be in communication with a server via a communication network (e.g., WAN and/or LAN). In some instances, first user device 1002 and second user device 1004 may be in communication via peer-to-peer communication protocol means (e.g., Bluetooth Low Energy, or Wi-Fi Direct). In some instances, a user carries second user device 1004 in the same room and may change position within the same room. In some instances, a position and orientation of each user device (e.g., first user device 1002, second user device 1004) located in the same room are monitored in real time, using internal sensors of each user device (when available) and/or external sensors (e.g., cameras) placed in the same room. The position and orientation of each user device obtained in real time are fed to, e.g., the server or one of first user device 1002 and second user device 1004, to generate for display a spatial map 1008 comprising a depiction of the same room, and icons assigned to each user device. First user device 1002 and second user device 1004 may be assigned an icon 1012 and an icon 1014, respectively. A position of an icon within spatial map 1008 is mapped to a position of a user device (the icon is assigned to) in the same room such that spatial map 1008 matches, in real time, the real world. This applies to each pair of icon/user device (e.g., icon 1012/first user device 1002, icon 1014/second user device 1004). In some instances, icon 1012 and icon 1014 may comprise information related to first user device 1002 and second user device 1004, respectively. In some instances, the related information may comprise features of the device (e.g., device type, display size, resolution, presentable sound frequency range, presentable sound intensity range, etc.), a real-time position of the device (e.g., real-time coordinates in a referential based on an x-axis, y-axis and z-axis), a real-time orientation of the device (e.g., real-time vector normal to a plane considered to represent the device, whose components on each of the x-axis, y-axis and z-axis indicate the real-time device orientation), one or more hyperlinks pertinent to the device (e.g., to access a webpage of a distributor or manufacturer of the device, a user manual of the device, a forum related to the device, etc.). In some instances, the related information may be accessible upon user interface input. In some instances, an application may control, upon user input and via a user profile, a presentation of the multi-component media content on first user device 1002 and second user device 1004, the user profile being associated with at least first user device 902 and second user device 1004. In some instances, the multi-component media content may comprise a first content 902a to be presented on first user device 1002 and of a second content 1004a to be presented on second user device 1004. In some instances, spatial map 1008 may be displayed, via the application, at first user device 1002 or second user device 1004 in order to be accessible to the user. The user can then position and orient second device 1004 in the same room relative to first user device 1002 so as to position icon 1014 in spatial map 1008 so as to purposely modify first content 1002a and/or second content 1004a.

In some instances, first user device 1002 may be stationary during a first period of time encompassing time points t₀ and t₁. The position and orientation of first user device 1002 are thus constant during the first period of time. A position of first user device 1002 may be expressed as, e.g., coordinates (x₂₁, y₂₁, z₂₁) of a center of gravity of first user device 902. First user device 1002 may be assimilated to a first plane. The orientation of first user device 902 may be expressed as a vector n₂₁ normal to the first plane, and having respective components on each of of x-axis, y-axis and z-axis so as to have the following coordinates (n₂₁ₓ, n_{21y}, n_{21z}). During the first period of time, the orientation of first user device 1002 being constant, the direction of the vector n₂₁ is constant and may be, for example, aligned with the x-axis.

In some instances, during the first period of time, second user device 1004 may move (e.g., upon a user movement, the user carrying second user device 1004) while the orientation of second user device 1004 may be fixed. A position of second user device 1004 may be expressed as, e.g., coordinates (x₂₂, y₂₂, z₂₂) of a center of gravity of second user device 1004. For instance, second user device 1004 may be assimilated to a second plane. The orientation of second user device 904 may be expressed as a vector n₂₂ normal to the second plane, and having respective components on each of of x-axis, y-axis and z-axis so as to have the following coordinates (n₂₂ₓ, n_{22y}, n_{22z}). During the first period of time, the orientation of second user device 1004 being constant, the direction of the vector n₂₂ is constant and may be, for example, aligned with the x-axis.

At time point t₀ associated with FIG. 10A, first user device 1002 (that is stationary) may be positioned in a room around a center of a background, the background being at a distance (e.g., a few meters) from the user. Second user device 1004 (that can move, for example, along the y-axis) may be initially positioned in the room around a center of a foreground, the foreground representing the user's immediate surroundings. Spatial map 1008 associated with time point t₀ accurately presents the positions of first user device 1002 and second user device 1004 via the depictions of assigned icons 1012 and 1014. At time point t₀, coordinates of first user device 1002 are (x₂₁, y₂₁, z₂₁)ₜ₀ and coordinates of vector n₂₁ are (n₂₁ₓ, n_{21y}, n_{21z})ₜ₀. At time point t₀, coordinates of second user device 1004 are (x₂₂, y₂₂, z₂₂)ₜ₀ and coordinates of vector n₂₂ are (n₂₂ₓ, n_{22y}, n_{22z})ₜ₀.

At time point t₀ associated with FIG. 10A, first user device 1002 may present first content 1002a associated with first user device 1002, wherein first content 1002a may depict a request to wipe first content 1002a (which presents a dirty surface) by holding second user device 1004 sufficiently close to first user device 1002 and mimicking wiping movements with second user device 1004, in order to receive a discount on a new sponge. Similarly, second user device 1004 may present second content 1004a associated with second user device 1004, wherein second content 1004a may depict a clean sponge so as to wipe clean the dirty surface presented in first content 1002a. Second user device 1004 is too far from first user device 1002 to modify first content 1002a by removing part of the dirt from the dirty surface, which would then modify second content 1004a by adding this part of dirt on the sponge, so as to materialize, through sequential modifications of first content 1002a and second content 1004a, a two-way interaction. A first dynamic synchronization parameter may define a first coherence between first content 1002a and second content 1004a. For instance, the first dynamic synchronization parameter may take into account the fact that second user device 1004 is too far from first user device 1002 such that second content 1004a cannot alter first content 1002a. This event (e.g., a sufficiently-large distance between first user device 1002 and second user device 1004) is associated with both a respective first version of a plurality of first versions of first content 1002a and a respective second version of a plurality of second versions of second content 1004a.

At time point t₁ associated with FIG. 10B, second user device 1004 may have been brought close to and in front of first user device 1002, and may have undergone a movement from a negative ‘y’ value to a positive ‘y’ value (from left to right in FIG. 10B) to remove some dirt for the dirty surface presented in first content 1002a. At time point t₁, the coordinates of second user device 1004 are (x₂₂, y₂₂, z₂₂)ₜ₁ and the coordinates of vector n₂₂ are (n₂₂ₓ, n_{22y}, n_{22z})ₜ₁. This change of position is accurately reflected in spatial map 1008. The position of each device (e.g., first user device 1002 and second user device 1004) is accurately depicted in spatial map 1008. In some instances, first content 1002a may present a clear area exempt of dirt and second content 1004a may present a sponge covered of dirt. Based on relative positions and orientations of first user device 1002 and second user device 1004, first content 1002a and second content 1004a may be updated. The first dynamic synchronization parameter may define an updated first coherence between first content 1002a and second content 1004a. For instance, there is a correspondence between the amount of dirt picked up by the sponge and the amount of dirt removed from the dirty surface. Additionally, both a first state history of each pixel of the display of the first device 1002 and a second state history of each pixel of the display of the second device 1004 should be updated in order to prevent a “clean” pixel of first content 1002a (initially presenting a dirty surface) from reverting to a “dirty” pixel and a “dirty” pixel of second content 1004a (initially presenting a clean sponge) from reverting to a “clean” pixel. The “dirty” pixel of second content 1004a may turn into a “dirtier” pixel if more dirt is picked up on the sponge. For instance, the first dynamic synchronization parameter may take into account the fact that second user device 1004 is close enough from first user device 1002 such that second content 1004a can alter first content 1002a and reciprocally. This event (e.g., a sufficiently-close distance between first user device 1002 and second user device 1004) is associated with both a respective first version of a plurality of first versions of first content 1002a and a respective second version of a plurality of second versions of second content 1004a, that allows for exchanging the dirt from first user device 1002 to second user device 1004.

FIG. 11 depicts a flow diagram 1100 of illustrative steps involved in the improved and coordinated presentation of a multi-component media content across multiple devices, in accordance with some implementations of the disclosure. In some instances, flow diagram 1100 may relate to updating device locations and generate next video frame.

In some instances, each of a device coordinator, a media manager, a device configured to generate a spatial map and a media database may be a server or a user device (e.g., a device of the multiple devices that are eligible to present a multi-component media content, such as first user device 102, 202, 902, 1002, second user device 104, 204, 904, 1004, or third user device 106). In some instances, a same device may comprise the device coordinator, the media manager, the device configured to generate a spatial map and the media database, the same device being a server or a user device (e.g., a device of the multiple devices that are eligible to present a multi-component media content, such as first user device 102, 202, 902, 1002, second user device 104, 204, 904, 1004, or third user device 106).

At step 1102, control circuitry of the first device (e.g., first user device 102, 202, 902, 1002) may start presenting a first content (e.g., first content 102a, 202a, 902a, 1002a) of the multi-component media content, wherein the first content is static.

At step 1104, control circuitry of the second device (e.g., second user device 104, 204, 904, 1004) may determine a change in position and orientation (e.g., in a referential based on an x-axis, y-axis and z-axis) using one or more internal sensors. In some instances, the control circuitry of the second device may send location data (e.g., position and orientations of the second device) to a device generating a spatial map (e.g., spatial map 208, 908 and 1008).

At step 1106, control circuitry of external sensors (e.g., cameras located in a same location as the first and second devices) may determine the change in position and orientation (e.g., in a referential based on an x-axis, y-axis and z-axis).

At step 1108, the control circuitry of the external sensors may send location data (e.g., position and orientations of first and second devices) related to first and second devices to the device generating the spatial map.

At step 1110, the control circuitry of the device generating the spatial map may update positions and orientations of the second and first devices on the spatial map.

From step 1110, there is a first path describing a situation where a multi-component media content is processed externally by a server through steps 1112, 1114, 1116 and 1118 to step 1126. Alternatively, there is a second path describing a situation where a multi-component media content is processed by a user device through steps 1120, 1122, 1124 to step 1126.

At step 1112, control circuitry of a media manager may retrieve updated positions and orientations of the first and second devices.

At step 1114, the control circuitry of the media manager may process (e.g., edit) next video frames of a second content (e.g., second content 104a, 204a, 904a, 1004a) for the second device, e.g., based on the updated positions and orientations of the first and second devices.

At step 1116, the control circuitry of the media manager may render next video frames of the second content for the second device.

At step 1118, the control circuitry of the media manager may send next video frames of the second content to the second device.

At step 1120, the control circuitry of the second device may retrieve the updated positions and orientations of the first and second devices.

At step 1122, the control circuitry of the second device may process (e.g., edit) next video frames of the second content for the second device, e.g., based on the updated positions and orientations of the first and second devices.

At step 1124, the control circuitry of the second device may render next video frames of the second content for the second device.

At step 1126, the control circuitry of the second device may present video frames of the second content on the second device.

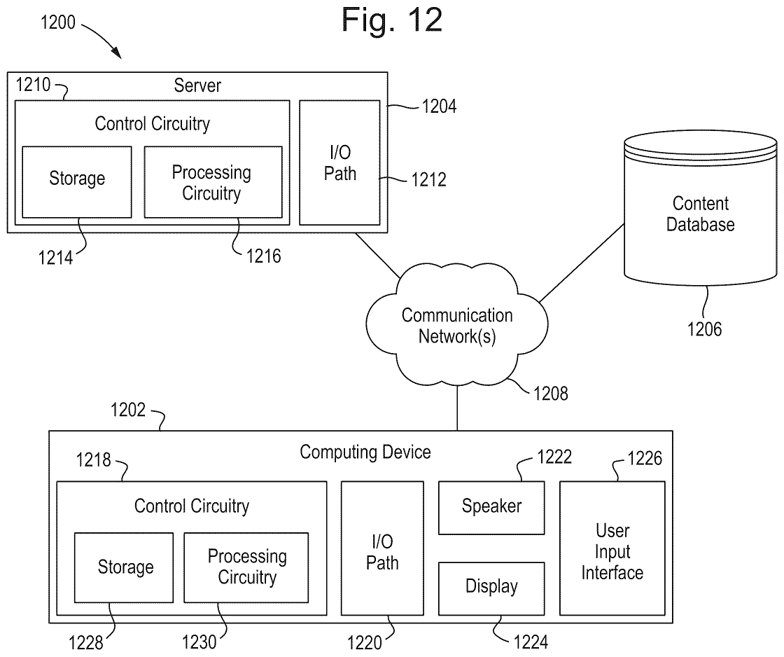

FIG. 12 represents a block diagram showing components of an example system 1200 for enabling the improved and coordinated presentation of a multi-component media content across multiple devices. Although FIG. 12 shows system 1200 as including a number and configuration of individual components, in some examples, any number of the components of system 1200 is combined and/or integrated as one device. System 1200 includes computing device 1202 (e.g., first device 102, 202, 902, 1002; second device 104, 204, 904, 1004; third device 106), server 1204 (e.g., a server coordinator depicted in FIGS. 4, 5, 6A and 6B; a media manager depicted in FIGS. 4, 5, 6A, 6B and 11; a device configured to generate spatial map depicted in FIGS. 4 and 11), and content database 1206 (e.g., a media database depicted in FIG. 5), each of which is communicatively coupled to communication network 1208, which is the Internet or any other suitable network or group of networks. In some examples, system 1200 excludes server 1204, and functionality that would otherwise be implemented by server 1204 is instead implemented by other components of system 1200, such as computing device 1202. In still other examples, server 1204 works in conjunction with computing device 1202 to implement certain functionality described herein in a distributed or cooperative manner.

Server 1204 includes control circuitry 1210 and input/output (I/O) path 1212, and control circuitry 1210 includes storage 1214 and processing circuitry 1216. Computing device 1202, which can be a personal computer, a laptop computer, a tablet computer, a smartphone, a smart television, a smart speaker, or any other type of computing device, includes control circuitry 1218, I/O path 1220, speaker 1222, display 1224, and user input interface 1226, which in some examples provides a user selectable option for enabling and disabling the display of modified closed captions. Control circuitry 1218 includes storage 1228 and processing circuitry 1230. Control circuitry 1210 and/or 1218 is based on any suitable processing circuitry such as processing circuitry 1216 and/or 1230. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and includes a multi-core processor (e.g., dual-core, quad-core, hexa-core, or any suitable number of cores). In some examples, processing circuitry is distributed across multiple separate processors, for example, multiple of the same type of processors (e.g., two Intel Core i9 processors) or multiple different processors (e.g., an Intel Core i7 processor and an Intel Core i9 processor).

Each of storage 1214, storage 1228, and/or storages of other components of system 1200 (e.g., storages of content database 1206, and/or the like) is an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 2D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each of storage 1214, storage 1228, and/or storages of other components of system 1200 is used to store various types of content, metadata, and or other types of data. Non-volatile memory also is used (e.g., to launch a boot-up routine and other instructions). Cloud-based storage is used to supplement storages 1214, 1228 or instead of storages 1214, 1228. In some examples, control circuitry 1210 and/or 1218 executes instructions for an application stored in memory (e.g., storage 1214 and/or 1228). Specifically, control circuitry 1210 and/or 1218 is instructed by the application to perform the functions discussed herein. In some implementations, any action performed by control circuitry 1210 and/or 1218 is based on instructions received from the application. For example, the application is implemented as software or a set of executable instructions that is stored in storage 1214 and/or 1228 and executed by control circuitry 1210 and/or 1218. In some examples, the application is a client/server application where only a client application resides on computing device 1202, and a server application resides on server 1204.

The application is implemented using any suitable architecture. For example, it is a stand-alone application wholly implemented on computing device 1202. In such an approach, instructions for the application are stored locally (e.g., in storage 1228), and data for use by the application is downloaded on a periodic basis (e.g., from an out-of-band feed, from an Internet resource, or using another suitable approach). Control circuitry 1218 retrieves instructions for the application from storage 1228 and process the instructions to perform the functionality described herein. Based on the processed instructions, control circuitry 1218 determines what action to perform when input is received from user input interface 1226.

In client/server-based examples, control circuitry 1218 includes communication circuitry suitable for communicating with an application server (e.g., server 1204) or other networks or servers. The instructions for carrying out the functionality described herein are stored on the application server. Communication circuitry includes a cable modem, an Ethernet card, or a wireless modem for communication with other equipment, or any other suitable communication circuitry. Such communication involves the Internet or any other suitable communication networks or paths (e.g., communication network 1208). In another example of a client/server based application, control circuitry 1218 runs a web browser that interprets web pages provided by a remote server (e.g., server 1204). For example, the remote server stores the instructions for the application in a storage device. The remote server processes the stored instructions using circuitry (e.g., control circuitry 1210) and/or generates displays. Computing device 1202 receives the displays generated by the remote server and displays the content of the displays locally via display 1224. This way, the processing of the instructions is performed remotely (e.g., by server 1204) while the resulting displays are provided locally on computing device 1202. Computing device 1202 receives inputs from the user via input interface 1226 and transmits those inputs to the remote server for processing and generating the corresponding displays.

A user sends instructions, e.g., to view an interactive media content item and/or selects one or more programming options of the interactive media content item, to control circuitry 1210 and/or 1218 using user input interface 1226. User input interface 1226 is any suitable user interface, such as a remote control, trackball, keypad, keyboard, touchscreen, touchpad, stylus input, joystick, speech recognition interface, gaming controller, or other user input interfaces. User input interface 1226 is integrated with or combined with display 1224, which can be a monitor, a television, a liquid crystal display (LCD), an electronic ink display, or any other equipment suitable for displaying visual images.

Server 1204 and computing device 1202 transmits and receives content and data via I/O path 1212 and 1220, respectively. For instance, I/O path 1212 and/or I/O path 1220 includes a communication port(s) configured to transmit and/or receive (for instance to and/or from content database 1206), via communication network 1208, content item identifiers, content metadata, natural language queries, and/or other data. Control circuitry 1210, 1218 is used to send and receive commands, requests, and other suitable data using I/O paths 1212, 1220. I/O paths 1212 of server 1200 and I/O paths 1220 of computing device 1202 each comprises I/O circuitry, e.g., network interface, port, bus, wire.

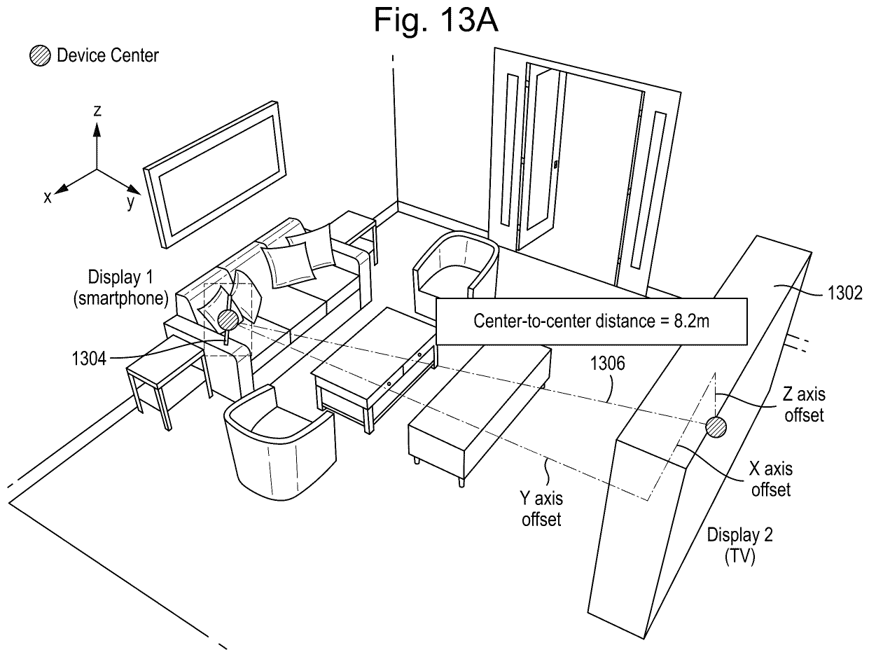

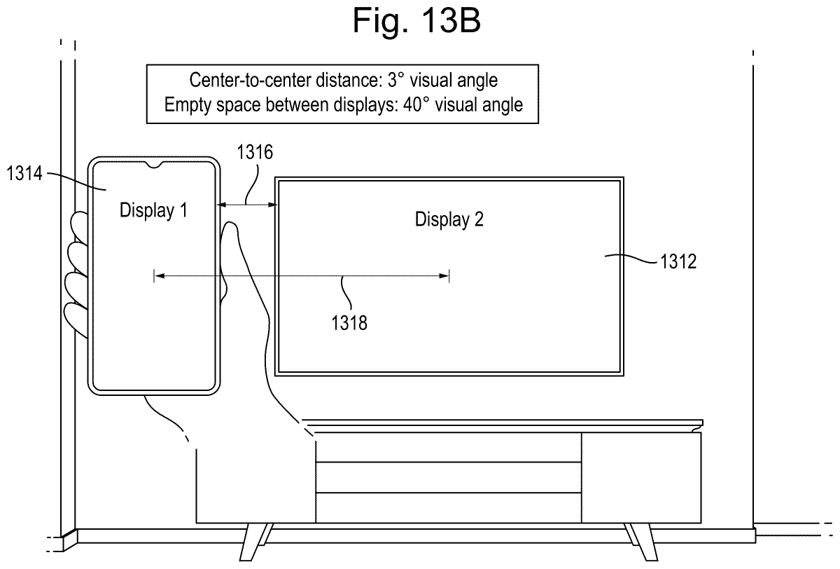

FIGS. 13A to 13B illustrates various ways to characterize a distance and/or an orientation between a first device and a second device configured to present a multi-component media content, in accordance with some implementations of the disclosure. When considering a relative arrangement (e.g., relative positions, relative orientations, distance) of devices (e.g., first and second devices comprising both a display), relevant features of said arrangement may be spatial (e.g., the distance 1306 between a center of a first device 1302 display and a center of a second device 1304 display depicted in FIG. 13A), or based on user perspective (e.g., the two device displays overlap by 1° of visual angle). For instance, a spatial distance refers to an objective measurement of the physical space between devices, expressed in a length unit (e.g., feet, meters). For example, a manifest (e.g., media presentation description) associated with a multi-component media content may comprise a requirement between a maximum distance between a first device and a second device (e.g., 10 meters). A perspective-based distance between a first device 1312 and a second device 1314 uses a position and an orientation of a specific user's head or eyes to recreate the user's perspective and identify a relative distance of devices in their field of view. The perspective-based distance is defined in terms of a visual angle, referring to a number of degrees of visual field between two points (e.g., center of gravity of each device). As a point of reference, when holding a hand at arm's length 1° roughly corresponds to a fingernail and 10° to a closed fist. FIG. 13B shows a few examples (e.g., perspective-based distance 1316, perspective-based distance 1318) of perspective-based distance between first device 1312 and second device 1314. For example, perspective-based distance 1316 is a distance between first device 1312 and second device 1314 (corresponding to an empty space between first device 1312 and second device 1314) equal to 40° visual angle. Perspective-based distance 1318 is a distance between a center of first device 1312 and a center of second device 1314, equal to 3° visual angle.

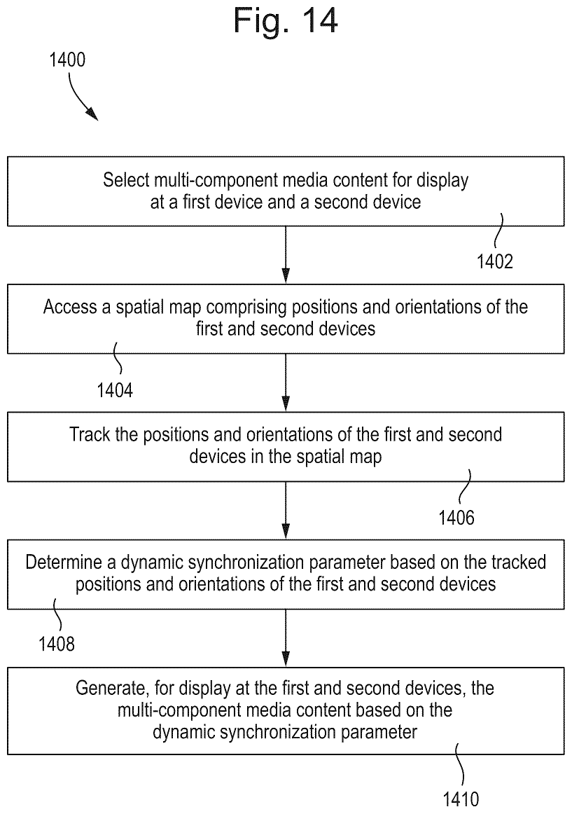

FIG. 14 depicts a flow diagram 1400 of illustrative steps involved in the improved and coordinated presentation of a multi-component media content across multiple devices, in accordance with some implementations of the disclosure.

At step 1402, control circuitry of a device (e.g., a server, or a user device such as first device 202, 902, 1002 or second device 204, 904, 1004) may select a multi-component media content (e.g., multi-display media content) for display at a first device (e.g., first device 102, 202, 902, 1002) and a second device (e.g., second device 104, 204, 904, 1004). In some instances, the multi-component media content may comprise a first content such as first content 102a, 202a, 902a, 1002a, for display at the first device, and a second content such as second content 204a, 904a, 1004a, for display at the second device. The control circuitry of the device may then proceed to step 1404.

At step 1404, the control circuitry of the device may access a spatial map (e.g., spatial map 208, 908, 1008) comprising positions and orientations of the first and second devices. In some instances, a position and an orientation of first device are determined by one or more sensors comprised in and/or outside the first device. Similarly, a position and an orientation of second device are determined by one or more sensors comprised in and/or outside the second device. Location data (e.g., position and orientation) associated with the first and second devices may be fed by the one or more sensors to the device or another device (e.g., server) configured to generate the spatial map. The control circuitry of the device may then proceed to step 1406.

At step 1406, the control circuitry of the device may track (e.g., in real time) the positions and orientations of the first and second devices in the spatial map. Location data associated with the first and second devices are provided in real-time to the device or the other device. The control circuitry of the device may then proceed to step 1408.

At step 1408, the control circuitry of the device may determine a dynamic synchronization parameter based on the tracked positions and orientations of the first and second devices. In some instances, the dynamic synchronization parameter may comprise a temporal component, a spatial component and/or a content-oriented component determining whether there is or not a cause/consequence relationship between the first content and the second content. The control circuitry of the device may then proceed to step 1410.

At step 1410, the control circuitry of the device may generate for display at the first and second devices, the multi-component media content based on the dynamic synchronization parameter.

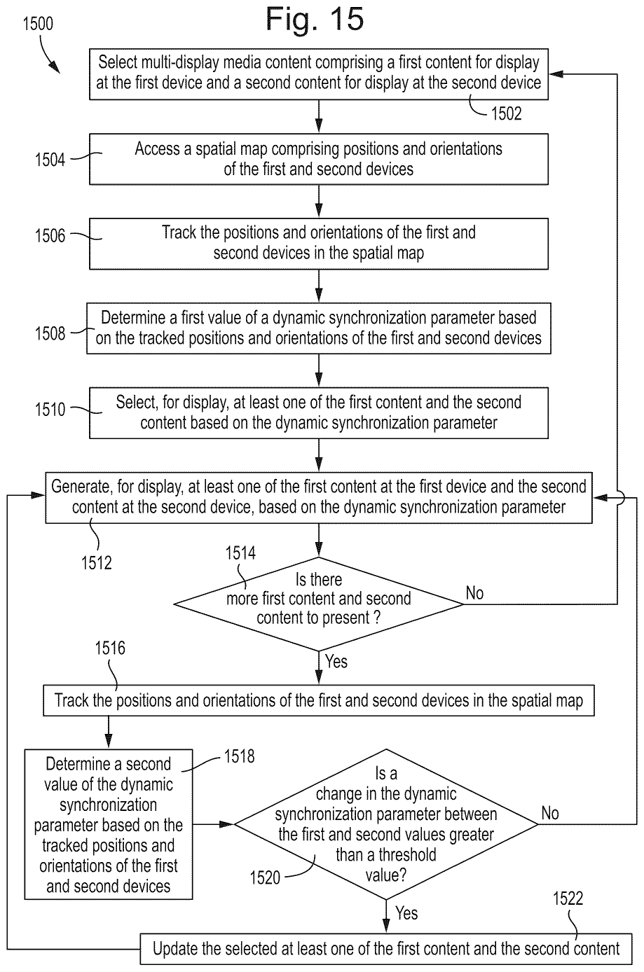

FIG. 15 shows a flow diagram 1500 of illustrative steps involved in the improved and coordinated presentation of a multi-component media content across multiple devices, in accordance with some implementations of the disclosure.

At step 1502, control circuitry of a device (e.g., a server, or a user device such as first device 102, 202, 902, 1002 or second device 104, 204, 904, 1004) may select multi-component media content (e.g., multi-display media content) comprising a first content (e.g., first content 102a, 202a, 902a, 1002a) for display at the first device (e.g., first device 102, 202, 902, 1002) and a second content (e.g., second content 104a, 204a, 904a, 1004a) for display at the second device (e.g., second device 104, 204, 904, 1004). The control circuitry of the device may proceed to step 1504.

At step 1504, the control circuitry of the device may access a spatial map (e.g., spatial map 208, 908, 1008) comprising positions and orientations of the first and second devices. In some instances, a position and an orientation of first device are determined by one or more sensors comprised in and/or outside the first device. Similarly, a position and an orientation of second device are determined by one or more sensors comprised in and/or outside the second device. Location data (e.g., position and orientation) associated with the first and second devices may be fed by the one or more sensors to the device or another device (e.g., server) configured to generate the spatial map. The control circuitry of the device may proceed to step 1506.

At step 1506, the control circuitry of the device may track (e.g., in real time) the positions and orientations of the first and second devices in the spatial map. Location data associated with the first and second devices are provided in real-time to the device or the other device. The control circuitry of the device may proceed to step 1508.

At step 1508, the control circuitry of the device may determine a first value of a dynamic synchronization parameter based on the tracked positions and orientations of the first and second devices. In some instances, the dynamic synchronization parameter may comprise a temporal component, a spatial component and/or a content-oriented component determining whether there is or not a cause/consequence relationship between the first content and the second content. The control circuitry of the device may then proceed to step 1510.

At step 1510, the control circuitry of the device may select for display, at least one of the first content and second content based on the dynamic synchronization parameter. The control circuitry of the device may proceed to step 1512.

At step 1512, the control circuitry of the device may generate, for display, at least one of the first content at the first device and the second content at the second device, based on the dynamic synchronization parameter. The control circuitry of the device may proceed to step 1514.

At step 1514, the control circuitry of the device may determine whether there is more first content and second content to present. If not, the control circuitry may then revert to step 1502, for example, so as to select a different multi-component media content, or a same multi-component media content with at least one of first content and second content different from the presented first content and second content. If so, the control circuitry may then proceed to step 1516.

At step 1516, the control circuitry of the device may track (e.g., in real time) the positions and orientations of the first and second devices in the spatial map. Location data associated with the first and second devices are provided in real-time to the device or the other device. The control circuitry of the device may proceed to step 1518.

At step 1518, the control circuitry of the device may determine a second value of the dynamic synchronization parameter based on the tracked positions and orientations of the first and second devices. The control circuitry of the device may then proceed to step 1520.

At step 1520, the control circuitry of the device may determine whether there is a change in the dynamic synchronization parameter between the first and second values greater than a threshold value. If not, the control circuitry may then revert to step 1512. In some instances, a first change in location data (e.g., position and orientation data) of the first device and a second change in location data (e.g., position and orientation) of the second device are both sufficiently small not to alter the first content and the second content. If so, the control circuitry may then proceed to step 1520. In some instances, at least one of a third change in location data (e.g., position and orientation data) of the first device and a fourth change in location data (e.g., position and orientation) of the second device is sufficiently large to alter both the first content and the second content.

At step 1522, the control circuitry of the device may update the selected at least one of the first content and the second content. The control circuitry may then revert to step 1512.

The processes described above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one example may be applied to any other example herein, and flow diagrams or examples relating to one example may be combined with any other example in a suitable manner, done in different orders, or done in parallel. In addition, the systems and methods described herein may be performed in real time. It should also be noted that the systems and/or methods described above may be applied to, or used in accordance with, other systems and/or methods.

1. A method of displaying content on multiple devices, the method comprising:
selecting multi-display media content for display at a first device and a second device, wherein the multi-display media content comprises a first content for display at the first device and a second content for display at the second device;
accessing a spatial map comprising positions and orientations of the first and second devices;
tracking the positions and orientations of the first and second devices in the spatial map;
determining a dynamic synchronization parameter based on the tracked positions and orientations of the first and second devices; and
generating, for display at the first and second devices, the multi-display media content based on the dynamic synchronization parameter, wherein the generating comprises:
(a) causing the first device to display the first content depicting an object or a character from a first perspective, and causing the second device to display the second content depicting the object or the character from a second perspective that is distinct from the first perspective; or
(b) causing the first device to display the first content depicting a first object or character, and causing the second device to display the second content depicting a second object or character, wherein an event occurs in the multi-display media content which impacts each of the depiction of the first object or character and the depiction of the second object or character.

2. The method of claim 1, wherein:
the method further comprises:
selecting, for display, the first content and the second content based on the dynamic synchronization parameter;
determining that a change in the dynamic synchronization parameter is greater than a threshold value; and
updating at least one of the first content or the second content when the change in the dynamic synchronization parameter is greater than a threshold value.

3. A method of displaying content on multiple devices comprising:
selecting multi-display media content for display at a first device and a second device, wherein the multi-display media content comprises a first content for display at the first device and a second content for display at the second device;
accessing a spatial map comprising positions and orientations of the first and second devices;
tracking the positions and orientations of the first and second devices in the spatial map;
determining a dynamic synchronization parameter based on the tracked positions and orientations of the first and second devices;
receiving a manifest having information relating to multiple bitstreams, each bitstream of the multiple bitstreams being associated with a respective device;
selecting, based on the dynamic synchronization parameter, a first bitstream of the multiple bitstreams for displaying the first content at the first device and a second bitstream of the multiple bitstreams for displaying the second content at the second device; and
generating, for display at the first and second devices, the multi-display media content based on the dynamic synchronization parameter.

4. The method of claim 3, wherein:
the manifest comprises information relating to a spatial relationship between the first device and the second device; and
the method further comprises:
mapping the spatial relationship between the first device and the second device to the tracked positions and orientations of the first and second devices.

5. The method of claim 1, further comprising:
receiving a first stream, at the first device, for displaying the multi-display media content, the first stream comprising a manifest having information relating to multiple bitstreams in the first stream;
selecting, based on the dynamic synchronization parameter, a first bitstream for displaying the first content at the first device and a second bitstream for displaying the second content at the second device; and
causing, by the first device, the second bitstream to be transmitted to the second device.

6. The method of claim 5, further comprising:
decoding the second bitstream into frames;
determining, based on the dynamic synchronization parameter, an adjustment parameter for modifying a display of the frames; and
generating, for display at the second device, the modified frames.

7. The method of claim 1, wherein:
the method further comprising:
initiating playing of the first content at the first device;
determining a timing component of the dynamic synchronization parameter based on the spatial map;
receiving, at the second device, an indication of playing of the first content at the first device;
exchanging the timing component between the first and second devices; and
initiating playing of the second content based on the receiving the indication and the timing component.

8. The method of claim 1, the method further comprising:
determining one or more capabilities the first device;
determining one or more capabilities of the second device;
selecting the first content for the first device based on the determined one or more capabilities of the first device; and
selecting the second content for the second device based on the determined one or more capabilities of the second device.

9. (canceled)

10. The method of claim 1, wherein:
the method further comprises:
determining a first occlusion state based on the spatial map, the first occlusion state being defined by at least a portion of one of the first and second devices occluding from view at least a portion of the other of the first and second devices;
selecting, based on the first occlusion state, the first content for display at the first device and the second content for display at the second device;
determining a change from the first occlusion state to a second occlusion state, the second occlusion state being defined by at least a portion of one of the first and second devices occluding from view at least a portion of the other of the first and second devices; and
updating, based on the change from the first occlusion state to the second occlusion state, the first content for display at the first device and the second content for display at the second device.

11. A system of displaying content on multiple devices, the system comprising:
input/output circuitry;
control circuitry configured to:
select multi-display media content for display at a first device and a second device, wherein the multi-display media content comprises a first content for display at the first device and a second content for display at the second device;
access, via the input/output circuitry, a spatial map comprising positions and orientations of the first and second devices;
track the positions and orientations of the first and second devices in the spatial map;
determine a dynamic synchronization parameter based on the tracked positions and orientations of the first and second devices; and
generate, for display at the first and second devices, the multi-display media content based on the dynamic synchronization parameter, wherein the generating comprises:
(a) causing the first device to display the first content depicting an object or a character from a first perspective, and causing the second device to display the second content depicting the object or the character from a second perspective that is distinct from the first perspective; or
(b) causing the first device to display the first content depicting a first object or character, and causing the second device to display the second content depicting a second object or character, wherein an event occurs in the multi-display media content which impacts each of the depiction of the first object or character and the depiction of the second object or character.

12. The system of claim 11, wherein:
the control circuitry is further configured to:
select, for display, the first content and the second content based on the dynamic synchronization parameter;
determine that a change in the dynamic synchronization parameter is greater than a threshold value; and
update at least one of the first content or the second content when the change in the dynamic synchronization parameter is greater than a threshold value.

13. The system of claim 11, wherein the control circuitry is further configured to:
receive a manifest having information relating to multiple bitstreams, each bitstream of the multiple bitstreams being associated with a respective device; and
select, based on the dynamic synchronization parameter, a first bitstream of the multiple bitstreams for displaying the first content at the first device and a second bitstream of the multiple bitstreams for displaying the second content at the second device.

14. The system of claim 13, wherein:
the manifest comprises information relating to a spatial relationship between the first device and the second device; and
the control circuitry is further configured to:
map the spatial relationship between the first device and the second device to the tracked positions and orientations of the first and second devices.

15. The system of claim 11, wherein the control circuitry is further configured to:
receive a first stream, at the first device, for displaying the multi-display media content, the first stream comprising a manifest having information relating to multiple bitstreams in the first stream;
select, based on the dynamic synchronization parameter, a first bitstream for displaying the first content at the first device and a second bitstream for displaying the second content at the second device; and
cause, by the first device, the second bitstream to be transmitted to the second device.

16. The system of claim 15, wherein the control circuitry is further configured to:
decode the second bitstream into frames;
determine, based on the dynamic synchronization parameter, an adjustment parameter for modifying a display of the frames; and
generate, for display at the second device, the modified frames.

17. The system of claim 11, wherein:
the control circuitry is further configured to:
initiate playing of the first content at the first device;
determine a timing component of the dynamic synchronization parameter based on the spatial map;
receive, at the second device, an indication of playing of the first content at the first device;
exchange the timing component between the first and second devices; and
initiate playing of the second content based on the receiving the indication and the timing component.

18. (canceled)

19. (canceled)

20. The system of claim 11, wherein:
the control circuitry is further configured to:
determine a first occlusion state based on the spatial map, the first occlusion state being defined by at least a portion of one of the first and second devices occluding from view at least a portion of the other of the first and second devices;
select, based on the first occlusion state, the first content for display at the first device and the second content for display at the second device;
determine a change from the first occlusion state to a second occlusion state, the second occlusion state being defined by at least a portion of one of the first and second devices occluding from view at least a portion of the other of the first and second devices; and
update, based on the change from the first occlusion state to the second occlusion state, the first content for display at the first device and the second content for display at the second device.

21-50. (canceled)

51. The method of claim 1, wherein the generating comprises (a) causing the first device to display the first content depicting the object or a character from the first perspective, and causing the second device to display the second content depicting the object or the character from the second perspective that is distinct from the first perspective, and wherein the first device is distinct from the second device.

52. The method of claim 51, wherein the first device is a television, and the second device is a mobile device.

53. The method of claim 1, wherein the generating comprises (b) causing the first device to display the first content depicting the first object or character, and causing the second device to display the second content depicting the second object or character, wherein the event occurs in the multi-display media content which impacts each of the depiction of the first object or character and the depiction of the second object or character, and wherein the event comprises an action performed by the first object or character in relation to the second object or character, and wherein the first device is distinct from the second device.
